(19) United States
(12) Patent Application Publication
(10) Pub. No.: US 2025/0335450 A1
(43) Pub. Date: Oct. 30, 2025

(54) USE CASE ADAPTATION OF AN AI ASSISTANT WITH PROMPT ENGINEERING

(71) Applicant: Snap Inc., Monica, CA (US)

(72) Inventors: Dmytro Ishchenko, Los Angeles, CA (US); Hee Hun Kim, Los Angeles, CA (US); Dmitry Matov, London (GB); Haowen Sun, Redmond, WA (US); Zhenning Tan, Union City, CA (US); Aleksandr Zakharov, Dubai (AE)

(21) Appl. No.: 19/192,865

(22) Filed: Apr. 29, 2025

Related U.S. Application Data
(60) Provisional application No. 63/639,869, filed on Apr. 29, 2024.

(51) Int. Cl. G06F 16/2457; G06F 16/28

(52) U.S. Cl. CPC G06F 16/24575; G06F 16/285

(57) ABSTRACT

System and method for an AI assistant, the system including receiving, at a computing device, a user query; determining a use case associated with the user query where the use case is a generic use case or a specific use case; upon determining that the use case for the query is the specific use case: retrieving context information relevant to the determined use case; generating a request for a response to the user query, the request including a prompt and a context, where the prompt includes the user query and the context includes context information relevant to the use case; transmitting the generated request to a first machine learning (ML) agent; retrieving, from the first ML agent, the response to the user query; storing the response to the user query at the computing device; and presenting the response to the user via a user interface (UI) of the computing device.

### CLAIM OF PRIORITY

This application claims the benefit of priority to U.S. Provisional Application Ser. No. 63/639,869, filed on Apr. 29, 2024, which is incorporated herein by reference in its entirety.

### TECHNICAL FIELD

The disclosed subject matter relates generally to the technical field of artificial intelligence (AI) assistants and/or agents and, in one specific example, to a system and method for adapting an AI assistant to particular use cases and/or evaluating versions of the AI assistant.

### BACKGROUND

The increasing adoption of AI assistants for answering questions and/or retrieving or organizing information has led to interest in techniques for ensuring that the AI assistants can be used in a wide variety of domains and for a wide variety of query types. Furthermore, the development of these techniques is associated with corresponding evaluation set-ups or frameworks.

### BRIEF DESCRIPTION OF THE SEVERAL VIEWS OF THE DRAWINGS

In the drawings, which are not necessarily drawn to scale, like numerals may describe similar components in different views. To easily identify the discussion of any particular element or act, the most significant digit or digits in a reference number refer to the figure number in which that element is first introduced. Some non-limiting examples are illustrated in the figures of the accompanying drawings in which:

FIG. 1 is a diagrammatic representation of a networked environment in which the present disclosure may be deployed, according to some examples.

FIG. 2 is a diagrammatic representation of a messaging system that has both client-side and server-side functionality, according to some examples.

FIG. 3 is a diagrammatic representation of an AI assistant, according to some examples.

FIG. 4 is a flowchart illustrating a method as implemented by an AI assistant, according to some examples.

FIG. 5 is a flowchart illustrating a method as implemented by an AI assistant, according to some examples.

FIG. 6 is a flowchart illustrating a method as implemented by an AI assistant and/or evaluation framework, according to some examples.

FIG. 7 is a block diagram showing a machine-learning program according to some examples.

FIG. 8 is a diagrammatic representation of a data structure as maintained in a database, according to some examples.

FIG. 9 is a diagrammatic representation of a message, according to some examples.

FIG. 10 is a diagrammatic representation of a machine in the form of a computer system within which a set of instructions may be executed to cause the machine to perform any one or more of the methodologies discussed herein, according to some examples.

FIG. 11 is a block diagram showing a software architecture within which examples may be implemented.

### DETAILED DESCRIPTION

Recent developments in query-answering and information retrieval technologies have led to increased interest in the development of AI assistants for answering user queries in the context of various applications, platforms, or systems. Existing AI assistants struggle with the specificity and/or the variability of user queries. For example, some user queries require domain-specific knowledge to be properly answered. However, many AI assistants default to trying to answer the query even if they lack the requisite domain-specific knowledge, which results in a suboptimal user experience. Users also expect AI assistants to handle a wide variety of queries, and can be disappointed when existing AI assistant solutions need to be corrected or steered towards the appropriate user intent over a long conversational session, especially when queries require a quick or compact answer and/or are made on a mobile device. Finally, users can be disappointed if frequently used AI assistants fluctuate in terms of the quality of their answers, and expect the AI assistants should improve over time as more interaction data becomes available to the system.

Therefore, there is a need for AI assistants that can correctly infer and/or address the intent, use case or information need associated with a user's query, for example by answering domain-specific or use case-specific queries using appropriate domain-specific or use case-specific content. Additionally, as AI assistants are deployed in increasingly complex environments, there is a need for scalable evaluation frameworks associated with AI assistant technologies, so that AI assistants can be more easily evaluated and improved over time.

Examples in the disclosure herein refer to an AI assistant that can adapt to specific use cases, enhancing its utility across various domains and query types. In some examples, the AI assistant uses a classification component capable of determining a generic or specific intent or use case associated with a user query. The AI assistant uses classification prompts to categorize queries with respect to one or more use cases. If the AI assistant determines that the query is associated with a specific use case, the AI assistant retrieves pertinent information related to the identified use case, such as help documents or FAQ documents associated with a help-seeking or FAQ-related query for a particular application or platform. Given the user query and the retrieved use-case specific information, the AI assistant can use an AI agent (e.g., a ML agent), such as a query-answering system, to generate a response to the user query that is grounded in or influenced by the use-case specific information. Thus, the AI assistant can provide a more contextually appropriate, more accurate and/or more relevant response to the user query.

In some examples, the AI assistant leverages one or more AI or machine learning (ML) agents, including trained large language models (LLMs), to process user queries and/or respond to them. For example, the AI assistant can provide such an AI agent with a prompt including instructions to answer the input query, as well as with a context or hint that includes a subset of the use case-specific relevant information. Differing prompt generation strategies and/or prompt modification strategies, such as prompt simplification or prompt augmentation, can help improve the quality of the response generated by the AI agent. Therefore, the AI assistant is associated with an evaluation framework that assesses, in an online or offline setting, the impact of prompt changes on the AI assistant's performance on evaluation query data sets. The evaluation framework includes definitions and/or guidelines for manually, automatically or semi-automatically assessed evaluation metrics. The evaluation framework enables the AI assistant to be adapted, in a scalable fashion, to meet evolving user needs.

In some examples, the AI assistant receives a user query. The AI assistant determines a use case associated with the user query, such as a generic use case or a specific use case. In some examples, determining the use case includes generating a classification request associated with the user query, where the classification request includes a classification-specific prompt containing descriptions of the generic use case and/or one or more specific use cases. The prompt can be a natural language (NL) prompt (e.g., written or spoken), an image or video prompt, or a multimodal prompt. The AI assistant can transmit the classification request to an AI agent, and receive, from the AI agent, the determined use case associated with the user query. The AI agent can be, for example, a large language model (LLM)-based agent.

If the user query is determined to be associated with a specific use case (e.g., application-related help seeking, FAQ information, and so forth), the AI assistant retrieves context information relevant to the specific use case (e.g., context information such as a set of documents describing features, help information or use instructions associated with a specific application or system). Retrieving relevant context information for the specific use case and/or query can include computing a query embedding associated with the user query, extracting a set of keywords from the user query and/or retrieving, based on the query embedding or the set of keywords, a set of documents relevant to the determined use case from a stored corpus. The stored corpus can contain use case-specific documents together with pre-computed document embeddings and/or available via a use case-specific API. The AI assistant can compute a relevance score, based on a pre-determined relevance measure, for each stored document embedding in the context of the user query. Alternatively, a subset of the stored document embeddings, corresponding to a subset of the stored documents, can be used for the relevance score computation. The computed relevance scores are ranked according to a predetermined ranking criterion, and a set of size K including the top K relevance scores (e.g., where K is a constant, K≥1), is identified. The documents associated with the top K relevance scores are returned as the context information relevant to the use case.

Given the user query, the specific use case and the retrieved use case-specific information, the AI assistant can generate a request for a response to the user query and/or transmit the request to an AI agent (which can be the same as the AI agent used by the query classification step). The request can include a prompt (e.g., a NL prompt) generated using an initial generation strategy. The request can also include a context. The prompt can include the user query, which can also be separately provided. The context can include a subset of the context information relevant to the use case. The context can be included in, or appended to, the prompt. The AI assistant can retrieve the response to the user query, store it, and/or present the response to the user via a user interface (UI) of a computing device.

In some examples, the AI assistant includes or is associated with an evaluation framework, for example as part of a larger evaluation and/or deployment framework. Given an initial prompt associated with a request type (e.g., a query classification request, a query answering request, etc.), the evaluation framework can generate prompts based on the initial prompt and/or one or more prompt modifications, such as prompt simplification or prompt augmentation. Alternatively, the additional prompts can be generated based on one or more additional prompt generation strategies. The evaluation framework accesses evaluation query datasets (e.g., conversation datasets, etc.) and/or assesses the quality and/or performance of prompts, prompt modifications and/or prompt generation strategies with respect to one or more pre-defined evaluation measures and one or more aggregate performance measures. The evaluation framework determines the one or more prompt generation and/or modification strategies that performed best for one or more evaluation query datasets, and that should therefore be used for improved user satisfaction and/or engagement.

### Networked Computing Environment

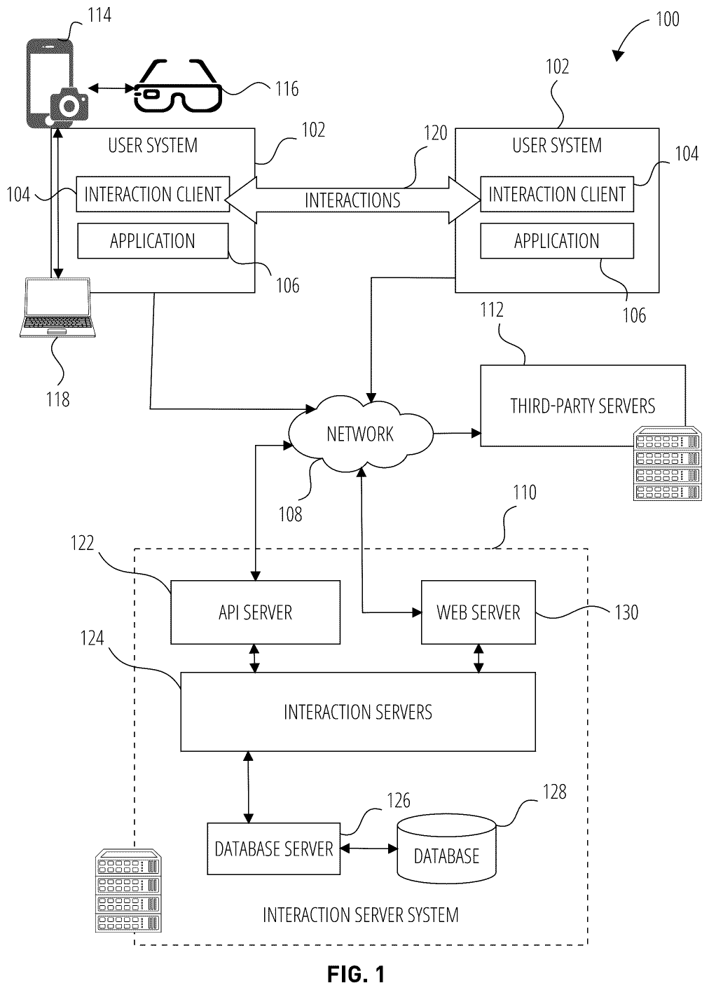

FIG. 1 is a diagrammatic representation of a networked environment in which the present disclosure may be deployed, according to some examples. FIG. 1 shows an example interaction system 100 for facilitating interactions (e.g., exchanging text messages, conducting text audio and video calls, or playing games) over a network. The interaction system 100 includes multiple user systems 102, each of which hosts multiple applications, including an interaction client 104 and other applications 106. Each interaction client 104 is communicatively coupled, via one or more communication networks including a network 108 (e.g., the Internet), to other instances of the interaction client 104 (e.g., hosted on respective other user systems 102), an interaction server system 110 and third-party servers 112). An interaction client 104 can also communicate with locally hosted applications 106 using Applications Program Interfaces (APIs).

Each user system 102 may include multiple user devices, such as a mobile device 114, head-wearable apparatus 116, and a computer client device 118 that are communicatively connected to exchange data and messages.

An interaction client 104 interacts with other interaction clients 104 and with the interaction server system 110 via the network 108. The data exchanged between the interaction clients 104 (e.g., interactions 120) and between the interaction clients 104 and the interaction server system 110 includes functions (e.g., commands to invoke functions) and payload data (e.g., text, audio, video, or other multimedia data).

The interaction server system 110 provides server-side functionality via the network 108 to the interaction clients 104. While certain functions of the interaction system 100 are described herein as being performed by either an interaction client 104 or by the interaction server system 110, the location of certain functionality either within the interaction client 104 or the interaction server system 110 may be a design choice. For example, it may be technically preferable to initially deploy particular technology and functionality within the interaction server system 110 but to later migrate this technology and functionality to the interaction client 104 where a user system 102 has sufficient processing capacity.

The interaction server system 110 supports various services and operations that are provided to the interaction clients 104. Such operations include transmitting data to, receiving data from, and processing data generated by the interaction clients 104. This data may include message content, client device information, geolocation information, media augmentation and overlays, message content persistence conditions, entity relationship information, and live event information. Data exchanges within the interaction system 100 are invoked and controlled through functions available via user interfaces (UIs) of the interaction clients 104.

Turning now specifically to the interaction server system 110, an Application Program Interface (API) server 122 is coupled to and provides programmatic interfaces to interaction servers 124, making the functions of the interaction servers 124 accessible to interaction clients 104, other applications 106 and third-party server 112. The interaction servers 124 are communicatively coupled to a database server 126, facilitating access to a database 128 that stores data associated with interactions processed by the interaction servers 124. Similarly, a web server 130 is coupled to the interaction servers 124 and provides web-based interfaces to the interaction servers 124. To this end, the web server 130 processes incoming network requests over the Hypertext Transfer Protocol (HTTP) and several other related protocols.

The Application Program Interface (API) server 122 receives and transmits interaction data (e.g., commands and message payloads) between the interaction servers 124 and the user systems 102 (and, for example, interaction clients 104 and other application 106) and the third-party server 112. Specifically, the Application Program Interface (API) server 122 provides a set of interfaces (e.g., routines and protocols) that can be called or queried by the interaction client 104 and other applications 106 to invoke functionality of the interaction servers 124. The Application Program Interface (API) server 122 exposes various functions supported by the interaction servers 124, including account registration; login functionality; the sending of interaction data, via the interaction servers 124, from a particular interaction client 104 to another interaction client 104; the communication of media files (e.g., images or video) from an interaction client 104 to the interaction servers 124; the settings of a collection of media data (e.g., a story); the retrieval of a list of friends of a user of a user system 102; the retrieval of messages and content; the addition and deletion of entities (e.g., friends) to an entity relationship graph (e.g., the entity graph 810); the location of friends within an entity relationship graph; and opening an application event (e.g., relating to the interaction client 104).

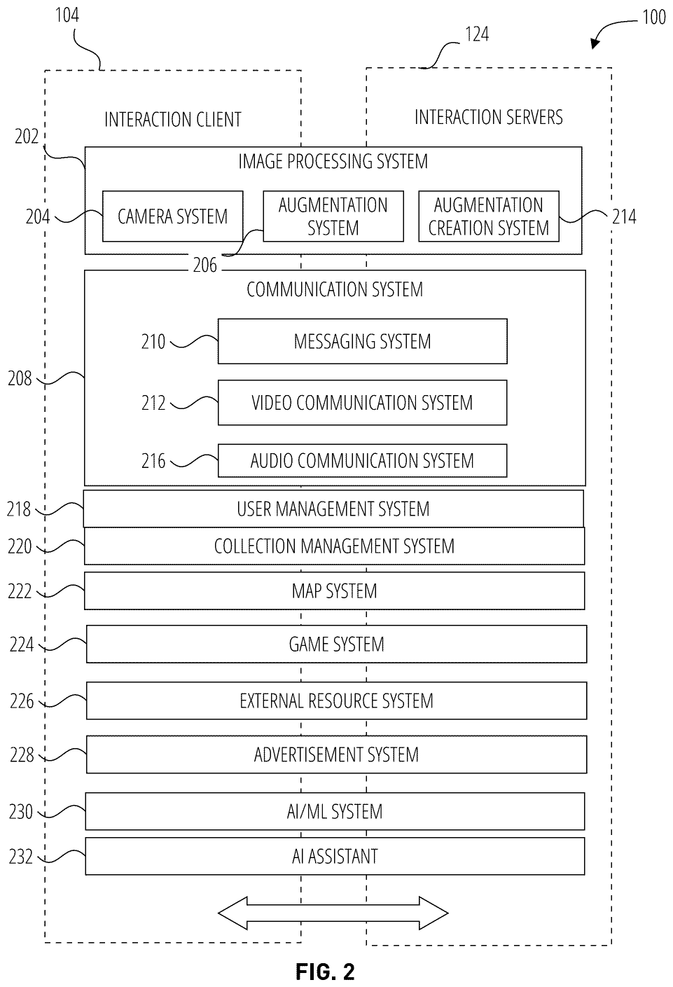

The interaction servers 124 host multiple systems and subsystems, described below with reference to FIG. 2.

### Linked Applications

Returning to the interaction client 104, features and functions of an external resource (e.g., a linked application 106 or applet) are made available to a user via an interface of the interaction client 104. In this context, “external” refers to the fact that the application 106 or applet is external to the interaction client 104. The external resource is often provided by a third party but may also be provided by the creator or provider of the interaction client 104.

The interaction client 104 receives a user selection of an option to launch or access features of such an external resource. The external resource may be the application 106 installed on the user system 102 (e.g., a “native app”), or a small-scale version of the application (e.g., an “applet”) that is hosted on the user system 102 or remote of the user system 102 (e.g., on third-party servers 112). The small-scale version of the application includes a subset of features and functions of the application (e.g., the full-scale, native version of the application) and is implemented using a markup-language document. In some examples, the small-scale version of the application (e.g., an “applet”) is a web-based, markup-language version of the application and is embedded in the interaction client 104. In addition to using markup-language documents (e.g., a .*ml file), an applet may incorporate a scripting language (e.g., a .*js file or a .json file) and a style sheet (e.g., a .*ss file).

In response to receiving a user selection of the option to launch or access features of the external resource, the interaction client 104 determines whether the selected external resource is a web-based external resource or a locally installed application 106. In some cases, applications 106 that are locally installed on the user system 102 can be launched independently of and separately from the interaction client 104, such as by selecting an icon corresponding to the application 106 on a home screen of the user system 102. Small-scale versions of such applications can be launched or accessed via the interaction client 104 and, in some examples, no or limited portions of the small-scale application can be accessed outside of the interaction client 104. The small-scale application can be launched by the interaction client 104 receiving, from a third-party server 112 for example, a markup-language document associated with the small-scale application and processing such a document.

In response to determining that the external resource is a locally installed application 106, the interaction client 104 instructs the user system 102 to launch the external resource by executing locally stored code corresponding to the external resource. In response to determining that the external resource is a web-based resource, the interaction client 104 communicates with the third-party servers 112 (for example) to obtain a markup-language document corresponding to the selected external resource. The interaction client 104 then processes the obtained markup-language document to present the web-based external resource within a user interface of the interaction client 104.

The interaction client 104 can notify a user of the user system 102, or other users related to such a user (e.g., “friends”), of activity taking place in one or more external resources. For example, the interaction client 104 can provide participants in a conversation (e.g., a chat session) in the interaction client 104 with notifications relating to the current or recent use of an external resource by one or more members of a group of users. One or more users can be invited to join in an active external resource or to launch a recently used but currently inactive (in the group of friends) external resource. The external resource can provide participants in a conversation, each using respective interaction clients 104, with the ability to share an item, status, state, or location in an external resource in a chat session with one or more members of a group of users. The shared item may be an interactive chat card with which members of the chat can interact, for example, to launch the corresponding external resource, view specific information within the external resource, or take the member of the chat to a specific location or state within the external resource. Within a given external resource, response messages can be sent to users on the interaction client 104. The external resource can selectively include different media items in the responses, based on a current context of the external resource.

The interaction client 104 can present a list of the available external resources (e.g., applications 106 or applets) to a user to launch or access a given external resource. This list can be presented in a context-sensitive menu. For example, the icons representing different ones of the application 106 (or applets) can vary based on how the menu is launched by the user (e.g., from a conversation interface or from a non-conversation interface).

### System Architecture

FIG. 2 is a block diagram 200 illustrating further details regarding the interaction system 100, according to some examples. Specifically, the interaction system 100 is shown to comprise the interaction client 104 and the interaction servers 124. The interaction system 100 embodies multiple subsystems, which are supported on the client-side by the interaction client 104 and on the server-side by the interaction servers 124. In some examples, these subsystems are implemented as microservices. A microservice subsystem (e.g., a microservice application) may have components that enable it to operate independently and communicate with other services. Example components of microservice subsystem may include:
Function logic: The function logic implements the functionality of the microservice subsystem, representing a specific capability or function that the microservice provides.
API interface: Microservices may communicate with each other components through well-defined APIs or interfaces, using lightweight protocols such as REST or messaging. The API interface defines the inputs and outputs of the microservice subsystem and how it interacts with other microservice subsystems of the interaction system 100.
Data storage: A microservice subsystem may be responsible for its own data storage, which may be in the form of a database, cache, or other storage mechanism (e.g., using the database server 126 and database 128). This enables a microservice subsystem to operate independently of other microservices of the interaction system 100.
Service discovery: Microservice subsystems may find and communicate with other microservice subsystems of the interaction system 100. Service discovery mechanisms enable microservice subsystems to locate and communicate with other microservice subsystems in a scalable and efficient way.
Monitoring and logging: Microservice subsystems may need to be monitored and logged in order to ensure availability and performance. Monitoring and logging mechanisms enable the tracking of health and performance of a microservice subsystem.

In some examples, the interaction system 100 may employ a monolithic architecture, a service-oriented architecture (SOA), a function-as-a-service (FaaS) architecture, or a modular architecture:

Example subsystems are discussed below.

An image processing system 202 provides various functions that enable a user to capture and augment (e.g., annotate or otherwise modify or edit) media content associated with a message.

A camera system 204 includes control software (e.g., in a camera application) that interacts with and controls hardware camera hardware (e.g., directly or via operating system controls) of the user system 102 to modify and augment real-time images captured and displayed via the interaction client 104.

The augmentation system 206 provides functions related to the generation and publishing of augmentations (e.g., media overlays) for images captured in real-time by cameras of the user system 102 or retrieved from memory of the user system 102. For example, the augmentation system 206 operatively selects, presents, and displays media overlays (e.g., an image filter or an image lens) to the interaction client 104 for the augmentation of real-time images received via the camera system 204 or stored images retrieved from memory of a user system 102. These augmentations are selected by the augmentation system 206 and presented to a user of an interaction client 104, based on a number of inputs and data, such as for example:
Geolocation of the user system 102; and
Entity relationship information of the user of the user system 102.

An augmentation may include audio and visual content and visual effects. Examples of audio and visual content include pictures, texts, logos, animations, and sound effects. An example of a visual effect includes color overlaying. The audio and visual content or the visual effects can be applied to a media content item (e.g., a photo or video) at user system 102 for communication in a message, or applied to video content, such as a video content stream or feed transmitted from an interaction client 104. As such, the image processing system 202 may interact with, and support, the various subsystems of the communication system 208, such as the messaging system 210 and the video communication system 212.

A media overlay may include text or image data that can be overlaid on top of a photograph taken by the user system 102 or a video stream produced by the user system 102. In some examples, the media overlay may be a location overlay (e.g., Venice beach), a name of a live event, or a name of a merchant overlay (e.g., Beach Coffee House). In further examples, the image processing system 202 uses the geolocation of the user system 102 to identify a media overlay that includes the name of a merchant at the geolocation of the user system 102. The media overlay may include other indicia associated with the merchant. The media overlays may be stored in the databases 128 and accessed through the database server 126.

The image processing system 202 provides a user-based publication platform that enables users to select a geolocation on a map and upload content associated with the selected geolocation. The user may also specify circumstances under which a particular media overlay should be offered to other users. The image processing system 202 generates a media overlay that includes the uploaded content and associates the uploaded content with the selected geolocation.

The augmentation creation system 214 supports augmented reality developer platforms and includes an application for content creators (e.g., artists and developers) to create and publish augmentations (e.g., augmented reality experiences) of the interaction client 104. The augmentation creation system 214 provides a library of built-in features and tools to content creators including, for example custom shaders, tracking technology, and templates.

In some examples, the augmentation creation system 214 provides a merchant-based publication platform that enables merchants to select a particular augmentation associated with a geolocation via a bidding process. For example, the augmentation creation system 214 associates a media overlay of the highest bidding merchant with a corresponding geolocation for a predefined amount of time.

A communication system 208 is responsible for enabling and processing multiple forms of communication and interaction within the interaction system 100 and includes a messaging system 210, an audio communication system 216, and a video communication system 212. The messaging system 210 is responsible for enforcing the temporary or time-limited access to content by the interaction clients 104. The messaging system 210 incorporates multiple timers (e.g., within an ephemeral timer system) that, based on duration and display parameters associated with a message or collection of messages (e.g., a story), selectively enable access (e.g., for presentation and display) to messages and associated content via the interaction client 104. The audio communication system 216 enables and supports audio communications (e.g., real-time audio chat) between multiple interaction clients 104. Similarly, the video communication system 212 enables and supports video communications (e.g., real-time video chat) between multiple interaction clients 104.

A user management system 218 is operationally responsible for the management of user data and profiles, and maintains entity information (e.g., stored in entity tables 808, entity graphs 810 and profile data 802) regarding users and relationships between users of the interaction system 100.

A collection management system 220 is operationally responsible for managing sets or collections of media (e.g., collections of text, image video, and audio data). A collection of content (e.g., messages, including images, video, text, and audio) may be organized into an “event gallery” or an “event story.” Such a collection may be made available for a specified time period, such as the duration of an event to which the content relates. For example, content relating to a music concert may be made available as a “story” for the duration of that music concert. The collection management system 220 may also be responsible for publishing an icon that provides notification of a particular collection to the user interface of the interaction client 104. The collection management system 220 includes a curation function that allows a collection manager to manage and curate a particular collection of content. For example, the curation interface enables an event organizer to curate a collection of content relating to a specific event (e.g., delete inappropriate content or redundant messages). Additionally, the collection management system 220 employs machine vision (or image recognition technology) and content rules to curate a content collection automatically. In certain examples, compensation may be paid to a user to include user-generated content into a collection. In such cases, the collection management system 220 operates to automatically make payments to such users to use their content.

A map system 222 provides various geographic location (e.g., geolocation) functions and supports the presentation of map-based media content and messages by the interaction client 104. For example, the map system 222 enables the display of user icons or avatars (e.g., stored in profile data 802) on a map to indicate a current or past location of “friends” of a user, as well as media content (e.g., collections of messages including photographs and videos) generated by such friends, within the context of a map. For example, a message posted by a user to the interaction system 100 from a specific geographic location may be displayed within the context of a map at that particular location to “friends” of a specific user on a map interface of the interaction client 104. A user can furthermore share his or her location and status information (e.g., using an appropriate status avatar) with other users of the interaction system 100 via the interaction client 104, with this location and status information being similarly displayed within the context of a map interface of the interaction client 104 to selected users.

A game system 224 provides various gaming functions within the context of the interaction client 104. The interaction client 104 provides a game interface providing a list of available games that can be launched by a user within the context of the interaction client 104 and played with other users of the interaction system 100. The interaction system 100 further enables a particular user to invite other users to participate in the play of a specific game by issuing invitations to such other users from the interaction client 104. The interaction client 104 also supports audio, video, and text messaging (e.g., chats) within the context of gameplay, provides a leaderboard for the games, and also supports the provision of in-game rewards (e.g., coins and items).

An external resource system 226 provides an interface for the interaction client 104 to communicate with remote servers (e.g., third-party servers 112) to launch or access external resources, i.e., applications or applets. Each third-party server 112 hosts, for example, a markup language (e.g., HTML5) based application or a small-scale version of an application (e.g., game, utility, payment, or ride-sharing application). The interaction client 104 may launch a web-based resource (e.g., application) by accessing the HTML5 file from the third-party servers 112 associated with the web-based resource. Applications hosted by third-party servers 112 are programmed in JavaScript leveraging a Software Development Kit (SDK) provided by the interaction servers 124. The SDK includes Application Programming Interfaces (APIs) with functions that can be called or invoked by the web-based application. The interaction servers 124 host a JavaScript library that provides a given external resource access to specific user data of the interaction client 104. HTML5 is an example of technology for programming games, but applications and resources programmed based on other technologies can be used.

To integrate the functions of the SDK into the web-based resource, the SDK is downloaded by the third-party server 112 from the interaction servers 124 or is otherwise received by the third-party server 112. Once downloaded or received, the SDK is included as part of the application code of a web-based external resource. The code of the web-based resource can then call or invoke certain functions of the SDK to integrate features of the interaction client 104 into the web-based resource.

The SDK stored on the interaction server system 110 effectively provides the bridge between an external resource (e.g., applications 106 or applets) and the interaction client 104. This gives the user a seamless experience of communicating with other users on the interaction client 104 while also preserving the look and feel of the interaction client 104. To bridge communications between an external resource and an interaction client 104, the SDK facilitates communication between third-party servers 112 and the interaction client 104. A bridge script running on a user system 102 establishes two one-way communication channels between an external resource and the interaction client 104. Messages are sent between the external resource and the interaction client 104 via these communication channels asynchronously. Each SDK function invocation is sent as a message and callback. Each SDK function is implemented by constructing a unique callback identifier and sending a message with that callback identifier.

By using the SDK, not all information from the interaction client 104 is shared with third-party servers 112. The SDK limits which information is shared based on the needs of the external resource. Each third-party server 112 provides an HTML5 file corresponding to the web-based external resource to interaction servers 124. The interaction servers 124 can add a visual representation (such as a box art or other graphic) of the web-based external resource in the interaction client 104. Once the user selects the visual representation or instructs the interaction client 104 through a GUI of the interaction client 104 to access features of the web-based external resource, the interaction client 104 obtains the HTML5 file and instantiates the resources to access the features of the web-based external resource.

The interaction client 104 presents a graphical user interface (e.g., a landing page or title screen) for an external resource. During, before, or after presenting the landing page or title screen, the interaction client 104 determines whether the launched external resource has been previously authorized to access user data of the interaction client 104. In response to determining that the launched external resource has been previously authorized to access user data of the interaction client 104, the interaction client 104 presents another graphical user interface of the external resource that includes functions and features of the external resource. In response to determining that the launched external resource has not been previously authorized to access user data of the interaction client 104, after a threshold period of time (e.g., 3 seconds) of displaying the landing page or title screen of the external resource, the interaction client 104 slides up (e.g., animates a menu as surfacing from a bottom of the screen to a middle or other portion of the screen) a menu for authorizing the external resource to access the user data. The menu identifies the type of user data that the external resource will be authorized to use. In response to receiving a user selection of an accept option, the interaction client 104 adds the external resource to a list of authorized external resources and allows the external resource to access user data from the interaction client 104. The external resource is authorized by the interaction client 104 to access the user data under an OAuth 2 framework.

The interaction client 104 controls the type of user data that is shared with external resources based on the type of external resource being authorized. For example, external resources that include full-scale applications (e.g., an application 106) are provided with access to a first type of user data (e.g., two-dimensional avatars of users with or without different avatar characteristics). As another example, external resources that include small-scale versions of applications (e.g., web-based versions of applications) are provided with access to a second type of user data (e.g., payment information, two-dimensional avatars of users, three-dimensional avatars of users, and avatars with various avatar characteristics). Avatar characteristics include different ways to customize a look and feel of an avatar, such as different poses, facial features, clothing, and so forth.

An advertisement system 228 operationally enables the purchasing of advertisements by third parties for presentation to end-users via the interaction clients 104 and also handles the delivery and presentation of these advertisements.

An AI/ML system 230 provides a variety of services to different subsystems within the interaction system 100. For example, the AI/ML system 230 operates with the image processing system 202 and the camera system 204 to analyze images and extract information such as objects, text, or faces. This information can then be used by the image processing system 202 to enhance, filter, or manipulate images. The AI/ML system 230 may be used by the augmentation system 206 to generate augmented content and augmented reality experiences, such as adding virtual objects or animations to real-world images. The communication system 208 and messaging system 210 may use the AI/ML system 230 to analyze communication patterns and provide insights into how users interact with each other and provide intelligent message classification and tagging, such as categorizing messages based on sentiment or topic. The AI/ML system 230 may also provide chatbot functionality to message interactions 120 between user systems 102 and between a user system 102 and the interaction server system 110. The AI/ML system 230 may also work with the audio communication system 216 to provide speech recognition and natural language processing capabilities, allowing users to interact with the interaction system 100 using voice commands.

An AI assistant 232 can be used by a user to retrieve answers and/or information, media assets (photos, videos, stories), users or contacts, third-party applications, and so forth. In some examples, the AI assistant 232 uses functionality provided by the AI/ML system 230, or can be integrated, partially or fully, in the AI/ML system 230.

### Example AI Assistant

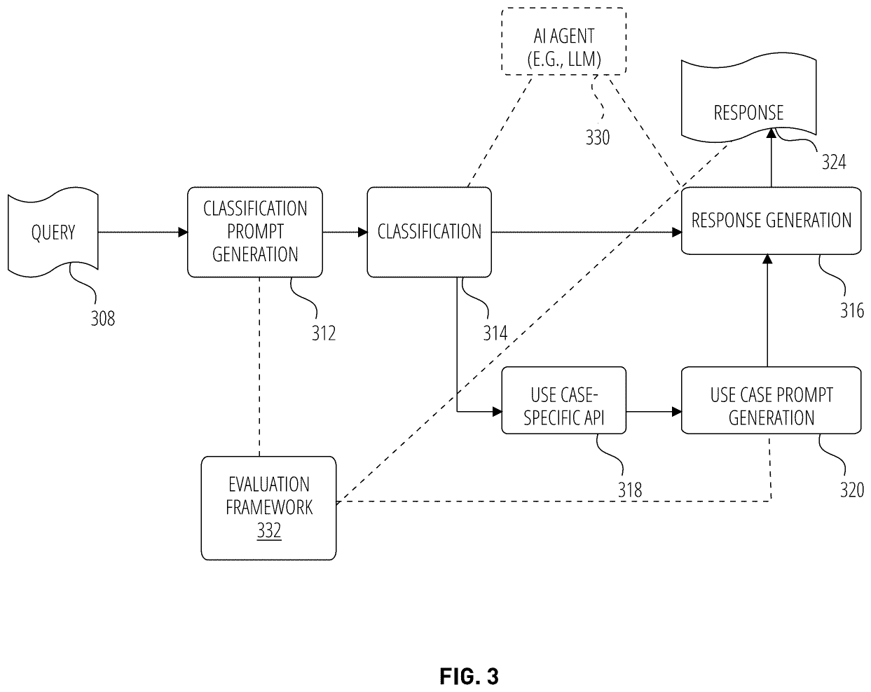

FIG. 3 is a diagrammatic representation 300 of an AI assistant 232, according to some examples. Given a query 308, the AI assistant 232 generates a classification prompt using the classification prompt generation 312. The classification prompt is used by the classification component 314 to classify the query with respect to a set of use cases. Use cases, or intents, are broadly construed to refer to information needs, domains, verticals, topics, and so forth.

Queries can be associated with a generic intent or general-purpose intent—for example, a query can be labeled as a generic query or general knowledge query that is answerable, in some examples, using information available on the Web (e.g., “what is the capital of Ecuador?”, etc). Alternatively, queries can be targeted queries associated with one or more specific use cases, intents or information needs. For example, queries can be classified as help-seeking queries (e.g., FAQ-type queries, help center-related queries for given application, etc.), topic-related queries in the context of a taxonomy of topics, place-related or location-related queries, lenses and/or stickers-related queries, and so forth. Some queries are answerable using past and/or unchanging information, while others are time-sensitive and/or require real-time or near real-time information. Therefore, queries can be classified as “time sensitive” or “real-time” (and conversely, “not time sensitive” or “not real-time”) or equivalent. An example classification prompt generated by the classification prompt generation 312 can include a request for a query to be classified, a description of the generic use case, a description of one or more specific use cases, a description of the time sensitivity determination, and/or examples of classified queries associated with one or all of the foregoing (e.g., examples of generic use case queries, specific use case queries, etc.).

In some examples, the classification component 314 is implemented via an AI agent 330. The AI agent 330 can use one or more machine learning (ML) models, such as trained large language models (LLMs) or other models. Given query 308, one or more trained LLMs and/or a classification prompt generated by the classification prompt generation 312, the AI agent 330 determines whether the query is a generic query or a targeted query associated with a specific intent or use case as described above. In some examples, the classification prompt includes descriptions of the generic query case, specific intent and/or use cases, and/or examples of generic queries and/or examples of queries illustrative of each specific intent and/or specific use case. In an illustrative example used throughout the disclosure herein, query 308 is associated with requesting help and/or FAQ-type information about an application or system. Such information includes details, instructions or help regarding the application functionality, settings, policies, and so forth. The application or system can be the messaging system 210, one of its components, or other internal or external applications and/or systems. While the help seeking intent is used herein merely for example, other query intents and/or query-associated use cases can be detected and/or handled in a similar manner. In some examples, the AI agent 330 uses an alternative or additional intent classification model, such as for example a trained machine-learned (ML) classifier that classifies a query based on a set of defined intents (e.g., generic intent, a set of specific intents, etc.) and/or previously labeled query examples for each of the defined intents.

If the classification component 314 determines that query 308 is a generic query, the response generation component 316 generates an answer or response 324 to the query, The response generation component 316 can be implemented via an AI agent, which can be the same AI agent 330. For example, the AI agent 330 can use one or more ML models (e.g., LLMs) to handle query answering and/or query classification as previously described.

If the classification component 314 determines that query 308 is a targeted query associated with a specific use case or intent (e.g., help/FAQ intent, etc.), the AI assistant 232 retrieves relevant use case-specific information associated with the query via a use case-specific API 318. Use case-specific information can directly correspond to an answer to the query. Use case-specific information can include one or more documents relevant to answering the query. Use-case specific information can be retrieved based on keywords automatically extracted from the query and/or based on computing and/or using one or more query embeddings, as seen below. The use case-specific API 318 can be a component of the AI assistant 232, or be associated with the AI assistant 232.

Upon retrieving use case-specific information, the AI assistant 232 generates a prompt via the use case prompt generation 320 component. The AI assistant 232 supplies the generated use case-associated prompt to the response generation component 316. In some examples, the AI assistant 232 supplies a hint or context including a subset of the use case-specific information (e.g., a proper subset or the entire use case-specific information) to the response generation component 316. The response generation component 316 queries the AI agent discussed above (e.g., the same AI agent 330 used by the classification component 314) using the prompt and/or the hint or context generated based on the provided use case-specific information. For example, retrieved use case-specific information, such as a set of documents retrieved from the use case-specific API 318, can be supplied as a hint or context to one or more LLMs used by the AI assistant 232. In some examples, the AI agent 330 bypasses the hint and/or context, providing an answer based on its already available knowledge. In some examples, the AI agent 330 uses the hint and/or context when formulating and/or retrieving the answer to the query.

### Example: Use Case-Specific Context Information

Given an example use case or intent (e.g., help or FAQ information associated with an application or system), the use case-specific API 318 retrieves, receives or accesses a set of documents relevant to the use case. The documents are preprocessed, for example by removing mark-up tags/templates, etc., and/or are summarized in K words or less (e.g., K=100/150/200/etc.). Such tasks can be accomplished using AI agent 330 (or other AI agents), and/or at least one specialized prompt such as a clean-up and/or summarization prompt. Given the set of documents, the use case-specific API 318 or an associated component can compute document embeddings (e.g., in a N-dimensional space, N=1024/2048/etc.). Computing embeddings for documents in the given document set can use an embeddings API, such as the OpenAI text-embeddings API or other third-party or internal APIs. Computed document embeddings are subsequently stored and/or indexed for retrieval via the use case-specific API 318.

For example, given a query, the AI assistant 232 or the use case-specific API 318 computes an embedding of the query (or an embedding of a reformulation of the query). Given such a query embedding, use case-specific API 318 retrieves the M most closely related or most relevant documents from a document set, where M is a constant (in some examples, bound by the total length of the selected documents). Retrieving such documents can be implemented by retrieving M nearest neighbors using a nearest neighbor method (e.g., approximate nearest neighbor (ANN), precise nearest neighbor (precise NN), and so forth). For example, a precise NN method can be implemented by iterating over all the candidate documents and computing a (document embedding, query embedding) similarity (e.g., a cosine similarity), followed by retaining the M documents most similar to the query. Additional or alternative retrieval methods can be used to retrieve M documents most relevant to the query using one or more of the query, automatically extracted query keywords and/or an embedding of the query. The retrieved documents can be provided as context and/or as hint information to one or more LLMs used by the AI assistant 232.

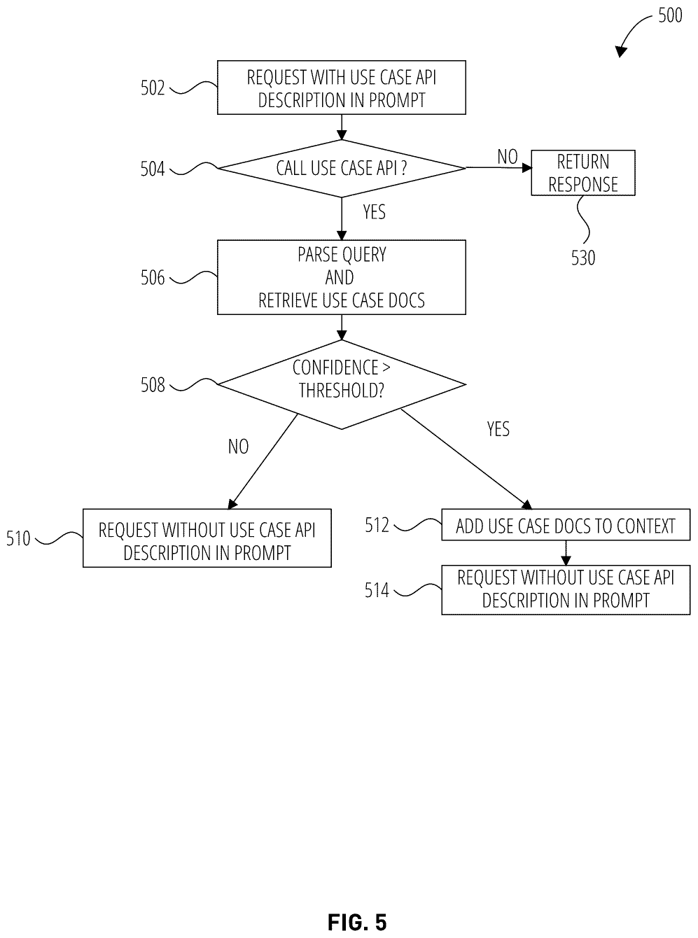

The AI assistant 232 can accomplish portions of the above workflow via custom requests to the AI agent 330. For example, the AI assistant 232 can use prompts that instruct an AI agent 330 to classify an input query with respect to intents or use cases. The AI assistant 232 can use system prompts to describe one or more use case-specific API 318 and/or give instructions to the AI agent 330 for when and how to use such APIs (see, e.g., FIG. 5 for more details).

### Example: Evaluation Framework

In some examples, the AI assistant 232 can include or be associated with an evaluation framework 332 as part of a larger evaluation and/or deployment framework. Responses obtained from the AI assistant 232 vary based on changes in instructions (e.g., prompts) used at different stages by the AI assistant 232. The AI assistant 232 and/or associated evaluation framework 332 provide tooling to enable both engineers and non-engineers to update prompts, as well as evaluate prompt changes. Such an evaluation can take place offline, to avoid costs associated with running production A/B tests for each prompt change. The evaluation can alternatively involve a mix of offline and online prompt change evaluation.

Given an initial prompt associated with a request type (e.g., a query classification request, a query answering request, etc.), the evaluation framework 332 can generate prompts based on the initial prompt and/or one or more prompt modifications, such as prompt simplification or prompt augmentation. Alternatively, the additional prompts can be generated based on one or more additional prompt generation strategies. The AI assistant 232 can transmit additional requests including the additional prompts (e.g., together with the same context information) to the AI agent 330, and retrieve corresponding additional responses to the user query which are transmitted to the evaluation framework 332.

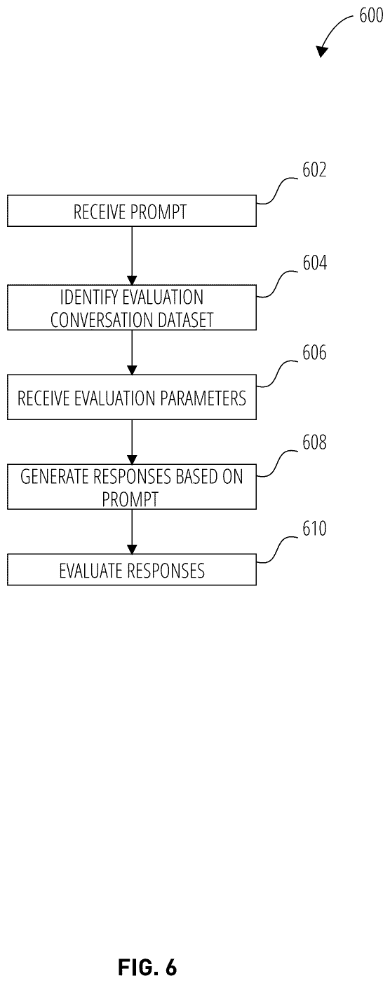

In some examples, the evaluation framework 332 retrieves a ground truth value and/or assessment for each user query or (user query, response) pair. The ground truth value can explicitly indicate an acceptable answer to the user query (e.g., in the case of a factual query), or a characteristic of the query (e.g., whether the query can be answered rather than declined/evaded, etc.) in the context of a predetermined evaluation metric. Alternatively, the ground truth value or assessment can indicate whether a retrieved response is satisfactory for the user query with respect to the predetermined evaluation metric (e.g., accuracy, relevance, etc.). The evaluation framework 332 uses the ground truth values, assessments and/or available responses to compute evaluation scores associated with each of the tested prompts, prompt modification strategies and/or prompt generation strategies. The computed evaluation scores can be automatically analyzed or ranked with respect to a predetermined criterion: for example, higher scores are preferable for metrics such as accuracy, while lower scores are preferred for metrics such as evasiveness (see, e.g., FIG. 6 for more details of the evasiveness metric). The N highest ranked scores according to the predetermined criterion can be retained together with their associated responses, prompts and/or prompt modification and/or prompt generation strategies (where N>=1 is a constant). Thus, the evaluation framework 332 can identify the prompt, prompt modification and/or prompt generation strategy that led to the best response to a particular user query in the context of the selected evaluation metric.

In some examples, the evaluation framework 332 accesses an evaluation query dataset, and repeats the operations above for some or all of the dataset queries, computing one or more aggregate performance measures for each prompt, prompt modification and/or prompt generation strategies over the dataset. For example, given a prompt generation strategy, the evaluation framework 332 can compute a performance measure corresponding to the percentage of queries in the dataset for which the prompt generation strategy led to the highest ranked response-related score among the prompt modification and/or generation strategies. Given a set of prompt generation and/or modification strategies, the evaluation framework 332 can compute a value of the same performance measure for each of the strategies in the set. The evaluation framework can rank the strategies with respect to the computed values of the performance measure, and identify the best-scoring N strategies, as indicated by the strategies with the top N highest values for the performance measure (where N is a pre-defined constant). In some examples, the performance measure is only computed for in-scope queries, as further described below. In some examples, the strategies are evaluated with respect to multiple performance measures in the context of the query dataset, and a set of N best-performing strategies is determined based on a combination of their performance measure values across some or all of the performance measures.

Thus, the evaluation framework determines the one or more prompt generation and/or modification strategies that performed best for the evaluation query dataset (according to one or more performance measures), and which should be further used for improved user satisfaction and/or engagement.

In some examples, the evaluation framework 332 accesses one or more responses corresponding to the one or more prompts generated using one or more prompt generation and/or prompt modification strategies. The evaluation framework displays, in a user interface (UI), the user query, response(s) and/or instructions associated with an evaluation metric of interest for the benefit of an annotator. In some examples, separate visual elements (such as columns, cells, tables, etc.) are used for the separate prompts, prompt generation or modification strategies and the associated responses, with the annotator selecting a preferred response for the given query. Upon receiving user selection input from the annotator, the evaluation framework 332 can store the selected or preferred response, prompt, prompt modification and/or prompt generation strategy for the user query. The evaluation framework 332 performs these operations for some or all queries in an evaluation query dataset, and determines a best performing prompt modification and/or prompt generation strategy based on one or more aggregate performance measures computed for the evaluation query dataset, as described above and also further in FIG. 6.

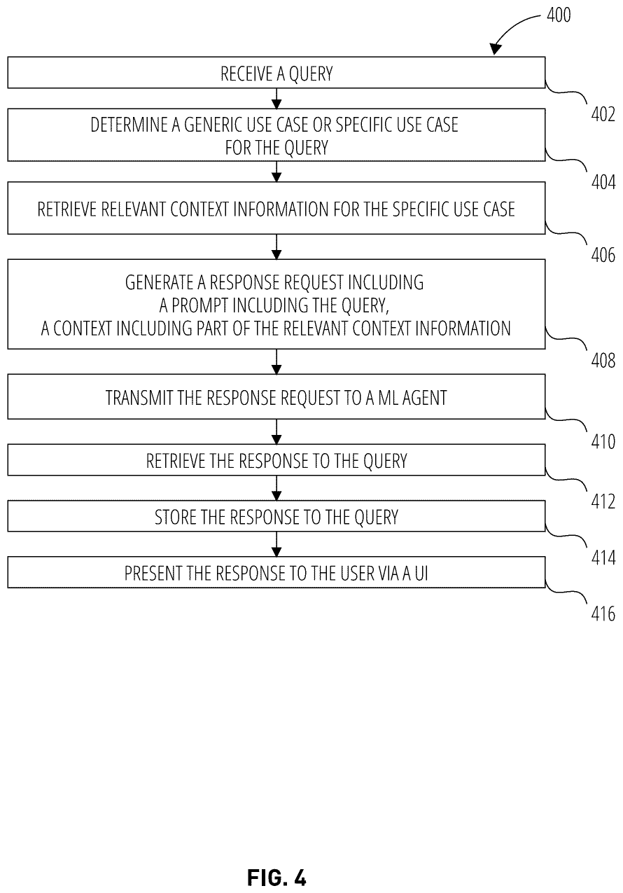

FIG. 4 is a flowchart illustrating method 400 as implemented by the AI assistant 232, according to some examples. At operation 402, AI assistant 232 receives, at a computing device, a user query. At operation 404, AI assistant 232 determines a use case associated with the user query, the use case being a generic use case or a specific use case (e.g., of a predetermined set of specific use cases, etc.). Given a specific use case, the AI assistant 232 retrieves, at operation 406, context information relevant to the given use case, such as relevant documents (e.g., FAQ information or application-specific help documents, etc.).

At operation 408, the AI assistant 232 generates a request for a response to the user query, the request including a prompt and/or a context. The prompt can include the user query, or the user query can be separately transmitted. The context includes a subset of the context information relevant to the use case. In some examples, the context is appended to the prompt, up to the length of an available context window.

At operation 410, the AI assistant 232 transmits the response request to an AI agent 330 (e.g., a ML agent such as a trained LLM model-based query answering agent, etc.). The AI assistant 232 retrieves a response to the user query from the AI agent 330 at operation 412. The received response is stored (see operation 414) and presented to the user via a user interface of the computing device (see operation 416).

FIG. 5 is a flowchart illustrating method 500 as implemented by an AI assistant 232 according to some examples. As mentioned in FIG. 3, the AI assistant 232 can accomplish some or all of the workflow in FIG. 3 (or equivalent) using one or more custom requests to the AI agent 330 (see, e.g., the associated example prompt further below).

For example, at operation 502, the AI assistant 232 makes a request to the AI agent 330 using a prompt that instructs the AI agent 330 to classify an input query with respect to intents or use cases, includes a description of the use case-specific API 318, and/or description of conditions for calling or bypassing use case-specific API 318, among others.

At operation 504, the AI assistant 232 (e.g., via the AI agent 330) decides whether the use case-specific API 318 should be called to answer the query. For example, generic queries do not trigger an API call for use case-specific API 318, while a use case-specific query associated with use case-specific API 318 triggers an API call for use case-specific API 318. In some examples, the AI assistant 232 includes, in the request to the AI agent 330, examples of generic and/or specific use case-related queries, together with additional instructions related to generating a response to the input query (see, e.g., the example system prompt included further below). The AI assistant 232 analyzes a response from the AI agent 330 to check whether the AI agent 330 has determined that the use case-specific API 318 should be called, in which case the response from the AI agent 330 includes a use case-specific API 318 call reference. If such a call reference is detected in the AI agent 330 response, the AI assistant 232 proceeds as per operation 506. Otherwise, the AI assistant 232 can proceed as per operation 530.

At operation 506, AI assistant 232 (e.g., via AI agent 330) automatically extracts keywords from the query. The query and/or keywords are transmitted to use case-specific API 318 and a set of documents relevant to the specific use case and/or query is retrieved via use case-specific API 318. The document retrieval can be implemented in multiple ways, such as using an embedding-based retrieval method (e.g., see FIG. 3 for details), a keyword-based document matching and/or retrieval method, and so forth.

At operation 508, the AI assistant 232 determines whether a confidence level in the retrieved documents is above a predefined threshold. In some examples, the confidence level corresponds to a measure of query-related relevance for the associated documents. Example relevance measures can include the magnitude of the cosine similarity between a query (e.g., query embedding) and a document (e.g., a document embedding). For example, the AI assistant 232 can determine whether the cosine similarity between the query and the closest, most similar retrieved document, is equal or greater than a predefined threshold (e.g., 0.75/0.80/etc.).

If the confidence level is assessed to be above the threshold level, one or more of the retrieved documents are included in a context or hint (at 512) for a query-answering request transmitted to AI agent 330 (at operation 514) in the context of the input query. Including the one or more documents is limited by the context window available for querying AI agent 330. The query-answering request can use a prompt that omits a description of the use case-specific API 318. If the confidence level is assessed to be below the threshold level, the AI assistant 232 transmits a request for a response to the input query to AI agent 330 (operation 510) without adding the use case documents as context. In some examples, the prompt associated with the request at operation 510 omits a description of the use case-specific API 318.

At operation 530, the AI assistant 232 can directly transmit a request to the AI agent 330 to generate a response to the input query. As discussed above, this operation is executed if the use case-specific API 318 does not need to be called (e.g., if the AI agent 330 has determined that the input query is generic, etc.). The prompt associated with the request at operation 530 can therefore omit the use case-specific API 318.

As described above, AI assistant 232 can provide AI agent 330 with a prompt describing a workflow or relevant workflow portions. In an illustrative example, the AI assistant 232 incorporates in an example prompt a description of the use case-specific API 318 for retrieving help or FAQ-type information associated with a particular application or platform or its features. The example prompt includes conditions under which the relevant use case-specific API 318 should be called by the AI agent 330 (e.g., “if the question is about [Platform] app or its features”, etc.). The AI Assistant 232 can instruct the AI agent 330 to directly answer the query if it refers to a generic and/or different topic.

### Example Prompt

<|im_start|>system
Consider [Platform] AI. [Platform] AI is a chat assistant for [Platform].
- [Platform] AI engages in casual conversation with the user.
- [Platform] AI's responses are short, positive, and interesting.
- [Platform] AI often uses emoji to convey an emotion or shorten the message
- [Platform] AI should never generate URLs or links
- If the question is about [Platform] or its features,
Platform AI must CALL help API to gather information, before finally giving a complete
ANSWER. The API works like that
- ‘call_api(″help_text″, {″keywords″: < terms> });‘ - to get related information about [Platform]
app from the help system. That is the only API available and API CALL must be used only for
questions about [Platform] app. All other questions should be answered without any help.
[Platform] AI will receive API responses after making each call.
- Each message from [Platform] AI should either begin with an ANSWER, to answer back to
the client or CALL, to make an API request. For example, to answer the question about the
[Platform] [feature], the assistant will first call an API like this - ‘CALL call_api(″help_text″,
{{″keywords″: ″[platform] [feature]″}})‘, then get a response, and finally answer the question
by incorporating all the retrieved information.
To answer a simple question like ″How are you?″, [Platform] AI writes the answer
immediately.
To answer a question not related to [Platform] like ″Is it raining in London?″ [Platform] AI
writes the answer immediately.
<|im_end|>

FIG. 6 is a flowchart illustrating method 600 for prompt evaluation, according to some examples, as implemented by an evaluation framework 332 associated with, or included in, an AI assistant 232. The evaluation framework 332 provides a UI for prompt engineering, prompt evaluation, or prompt change evaluation. In some examples, the UI can be provided by spreadsheets (e.g., Google Sheets, Microsoft Excel, Microsoft Sheets, etc.) and/or code notebooks (e.g., Google Colab notebooks, Jupyter notebooks). Spreadsheets can include prompts (e.g., prompt options) updated programmatically or based on user input, as well as query datasets or conversation datasets used for evaluating prompts or prompt changes, one or more evaluation metrics and/or associated evaluation setups including instructions, metrics, aggregate performance computations, and so forth. Spreadsheets can supply prompt options and query dataset information to shared code notebooks (e.g., Google Colab notebooks, Jupyter notebooks) used to invoke the AI assistant 232's query classification and/or answer generating capabilities for one or more queries in the query datasets. The notebooks can also take as input evaluation parameters, as seen below. The responses retrieved from the AI assistant 232 can be uploaded to the spreadsheets for manual, semi-automatic or automatic evaluation.

At operation 602, the evaluation framework 332 receives a prompt or prompt selection. For example, the evaluation framework 332 uses a notebook (e.g., a notebook copy) that takes input from a specific spreadsheet and transmits output to the spreadsheet. The prompt can be received from or retrieved from the spreadsheet. The prompt can be generated or updated in the spreadsheet based on user-provided input, or based on input received from one or more prompt updating or generating component that can be part of a spreadsheet or part of a notebook.

At operation 604, the evaluation framework 332 identifies one or more query datasets or conversation datasets used for evaluating the prompt. In some examples, the datasets are found in the specific spreadsheet of operation 602 and the notebook from operation 602 is updated to indicate the source of the datasets accordingly.

At operation 606, the evaluation framework 332 receives parameters such as LLM model name and/or version (e.g., GPT-3.5, GPT-4, Claude 2.0, Claude 2.1, Claude 3.0 (Opus), and so forth), user data such as user geolocation, age, etc., and/or the specified spreadsheet to which automatically generated responses should be transmitted for manual or automatic evaluation. Such parameters can be transmitted to the notebook described at operation 602.

At operation 608, the evaluation framework 332 uses the AI assistant 232 (for example, via the notebook of operation 602) to generate responses based on the prompt or prompt selection at operation 602 and one or more of the queries in the one or more query datasets of interest (see operation 604). The response generation uses the evaluation parameters of operation 606.

At operation 610, the evaluation framework 332 evaluates the generated responses in the context of the one or more used query datasets and/or their source spreadsheet(s), as indicated above. The evaluation is performed with respect to the one or more evaluation metrics indicated in the source spreadsheet(s). For fast extensive evaluation that eschews the use of potentially expensive A/B tests, the evaluation framework 332 can use an offline evaluation setup. Alternatively, the evaluation framework 332 can use a mix of offline and online evaluation.

Evaluation Metrics Example evaluation metrics include relevance, accuracy, helpfulness, toxicity, snappiness, evasiveness of the responses and so forth. The evaluation framework 332 can include a set of guidelines used by the human annotators to evaluate (query, response) pairs with respect to one or more evaluation metrics (as previously detailed in FIG. 3). The evaluation framework 332 can also include one or more automatic evaluation mechanisms for one or more of the metrics of interest, as seen below.

In an illustrative example, the evaluation framework 332 automatically evaluates the query-answering performance of the AI assistant 232 with respect to an evasiveness metric. Evasiveness characterizes cases when the AI assistant 232 declines to generate direct answers for queries (e.g., knowledge search queries, open-ended questions) even when it has the capacity to do so. Evasiveness is measured for all input queries (e.g., all queries in an evaluation query dataset are considered in-scope for evaluation), or for one or more relevant subsets of the input queries, according to predetermined criteria. For example, time-sensitive queries whose answers depend on a fast-changing knowledge base can be considered out-of-scope and be excluded from evaluation based on the evasiveness metric. Alternatively, they can be considered in-scope and evaluated. As part of this setup, the AI assistant 232's response for an input query is considered evasive if the AI assistant 232 does not generate a direct answer, but an AI agent (such as AI agent 330, etc.) presented with the same input query does. The response is considered non-evasive if the AI assistant 232 does generate a direct answer. Given a query dataset, the evaluation framework 332 computes an overall evasiveness metric value as #evasiveQueries/(#evasiveQueries+#non-evasiveQueries), where #evasiveQueries is the number of in-scope queries for which the AI assistant 232 has been evasive, while #non-evasiveQueries is the number of in-scope queries for which the AI assistant 232 has generated a direct answer. The out-of-scope dataset queries are not included in the metric computation.

Given available evaluation datasets, prompts and/or hints used by the AI assistant 232 can be modified and/or tested using the evaluation framework 332 as described above to identify prompt and/or hint versions that lead to reduced evasiveness over the one or more evaluation datasets. Thus, the AI assistant 232 can determine, for example, simplified or more targeted prompts that lead to reduced evasiveness.

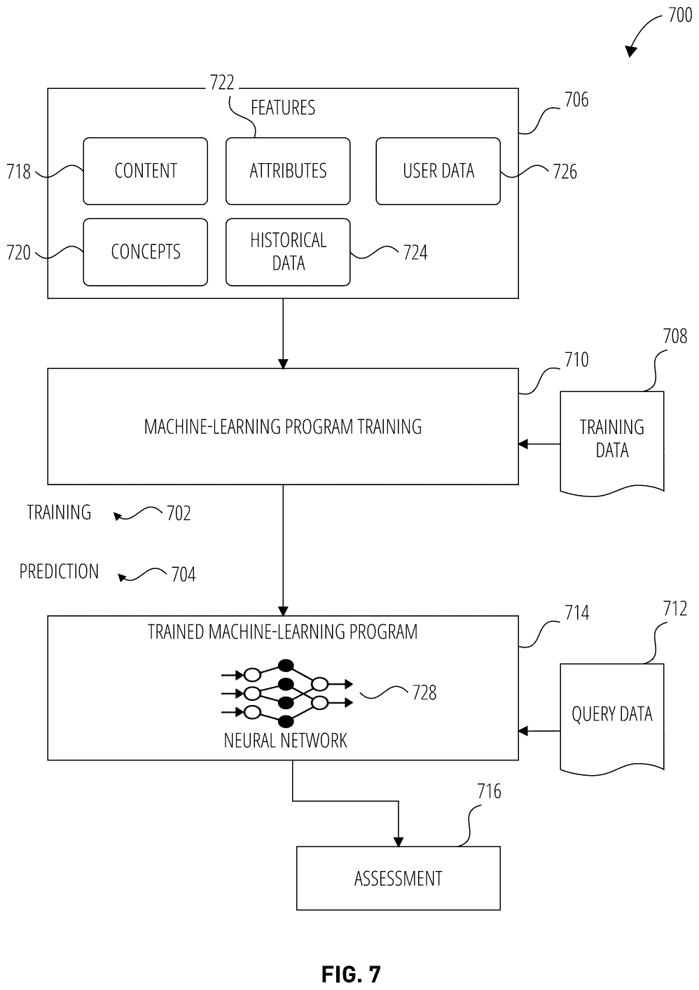

FIG. 7 is a block diagram showing a machine-learning program 700 according to some examples. The machine-learning program 700, also referred to as machine-learning algorithms or tools, are used to train machine learning models, which can be used by the AI assistant 232, as described at least in FIG. 3 herein.

Machine learning is a field of study that gives computers the ability to learn without being explicitly programmed. Machine learning explores the study and construction of algorithms, also referred to herein as tools, that may learn from or be trained using existing data and make predictions about or based on new data. Such machine-learning tools operate by building a model from example training data 708 in order to make data-driven predictions or decisions expressed as outputs or assessments (e.g., assessment 716). Although examples are presented with respect to a few machine-learning tools, the principles presented herein may be applied to other machine-learning tools.

In some examples, different machine-learning tools may be used. For example, Logistic Regression (LR), Naive-Bayes, Random Forest (RF), Gradient Boosted Decision Trees (GBDT), neural networks (NN), matrix factorization, and Support Vector Machines (SVM) tools may be used. In some examples, one or more ML paradigms may be used: binary or n-ary classification, semi-supervised learning, etc. In some examples, time-to-event (TTE) data will be used during model training. In some examples, a hierarchy or combination of models (e.g. stacking, bagging) may be used.

Two common types of problems in machine learning are classification problems and regression problems. Classification problems, also referred to as categorization problems, aim at classifying items into one of several category values (for example, is this object an apple or an orange?). Regression algorithms aim at quantifying some items (for example, by providing a value that is a real number).

The machine-learning program 700 supports two types of phases, namely a training phase 702 and prediction phase 704. In a training phase 702, supervised learning, unsupervised or reinforcement learning may be used. For example, the machine-learning program 700 (1) receives features 706 (e.g., as structured or labeled data in supervised learning) and/or (2) identifies features 706 (e.g., unstructured or unlabeled data for unsupervised learning) in training data 708. In a prediction phase 704, the machine-learning program 700 uses the features 706 for analyzing input (or query) data 712 to generate outcomes or predictions, as examples of an assessment 716.

In the training phase 702, feature engineering is used to identify features 706 and may include identifying informative, discriminating, and independent features for the effective operation of the machine-learning program 700 in pattern recognition, classification, and regression. In some examples, the training data 708 includes labeled data, which is known data for pre-identified features 706 and one or more outcomes. Each of the features 706 may be a variable or attribute, such as individual measurable property of a process, article, system, or phenomenon represented by a data set (e.g., the training data 708). Features 706 may also be of different types, such as numeric features, strings, and graphs, and may include one or more of content 718, concepts 720, attributes 722, historical data 724 and/or user data 726, merely for example.

In training phases 702, the machine-learning program 700 uses the training data 708 to find correlations among the features 706 that affect a predicted outcome or assessment 716.

With the training data 708 and the identified features 706, the machine-learning program 700 is trained during the training phase 702 at machine-learning program training 710. The machine-learning program 700 appraises values of the features 706 as they correlate to the training data 708. The result of the training is the trained machine-learning program 714 (e.g., a trained or learned model).

Further, the training phases 702 may involve machine learning (such as deep learning), in which the training data 708 is structured (e.g., labeled during preprocessing operations), and the trained machine-learning program 714 implements a neural network 728 (or one of other machine learning models, as described herein) capable of performing, for example, classification and clustering operations. In other examples, the training phase 702 may involve training data 708 which is unstructured, and the trained machine-learning program 714 implements a deep neural network 728 that is able to perform both feature extraction and classification/clustering operations.

A neural network 728 generated or trained during the training phase 702 and implemented within the trained machine-learning program 714, may include a hierarchical (e.g., layered) organization of neurons. For example, neurons (or nodes) may be arranged hierarchically into a number of layers, including an input layer, an output layer, and multiple hidden layers. The layers within the neural network 728 can have one or many neurons, and the neurons operationally compute a small function (e.g., activation function). For example, if an activation function generates a result that transgresses a particular threshold, an output may be communicated from that neuron (e.g., transmitting neuron) to a connected neuron (e.g., receiving neuron) in successive layers. Connections between neurons also have associated weights, which define the influence of the input from a transmitting neuron to a receiving neuron.

In some examples, the neural network 728 may also be one of a number of different types of neural networks, including a single-layer feed-forward network, an Artificial Neural Network (ANN), a Recurrent Neural Network (RNN), a symmetrically connected neural network, and unsupervised pre-trained network, a Convolutional Neural Network (CNN), or a Recursive Neural Network (RNN), a network with a transformer architecture, and so forth (merely for example).

During prediction phases 704 the trained machine-learning program 714 is used to perform an assessment. Query data 712 is provided as an input to the trained machine-learning program 700, and the trained machine-learning program 714 generates the assessment 716 as output, responsive to receipt of the query data 712.

In some examples, one or more artificial intelligence agents, such as one or more machine-learned algorithms or models and/or a neural network of one or more machine-learned algorithms or models may be trained iteratively (e.g., in a plurality of stages) using a plurality of sets of input data. For example, a first set of input data may be used to train one or more of the artificial agents. Then, the first set of input data may be transformed into a second set of input data for retraining the one or more artificial intelligence agents. The continuously updated and retrained artificial intelligence agents may then be applied to subsequent novel input data to generate one or more of the outputs described herein.

### Data Architecture

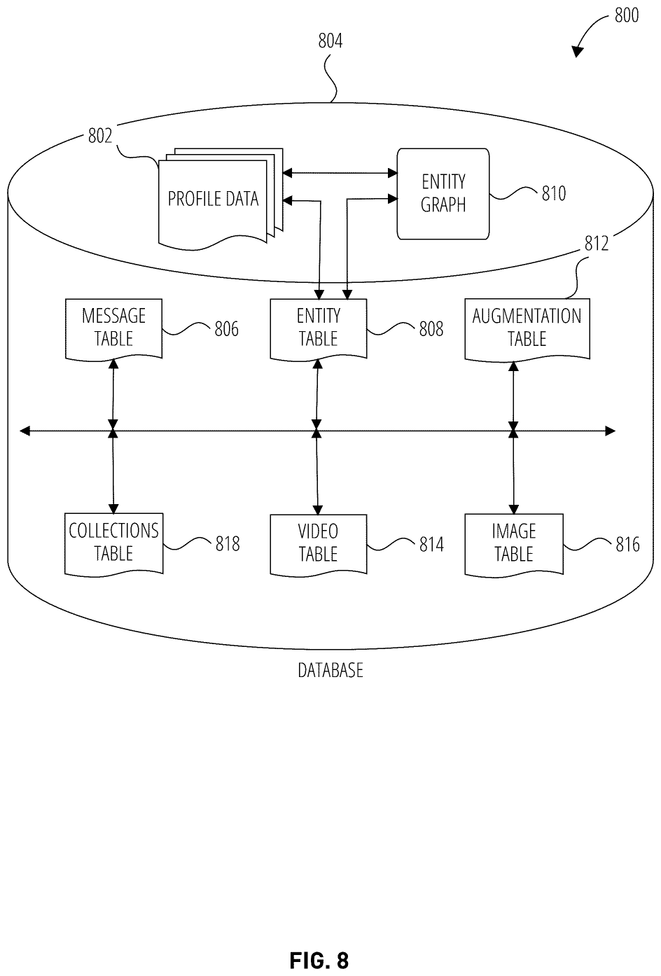

FIG. 8 is a schematic diagram illustrating data structures 800, which may be stored in the database 804 of the interaction server system 110, according to certain examples. While the content of the database 804 is shown to comprise multiple tables, it will be appreciated that the data could be stored in other types of data structures (e.g., as an object-oriented database).

The database 804 includes message data stored within a message table 806. This message data includes, for any particular message, at least message sender data, message recipient (or receiver) data, and a payload. Further details regarding information that may be included in a message, and included within the message data stored in the message table 806, are described below with reference to FIG. 8.

An entity table 808 stores entity data, and is linked (e.g., referentially) to an entity graph 810 and profile data 802. Entities for which records are maintained within the entity table 808 may include individuals, corporate entities, organizations, objects, places, events, and so forth. Regardless of entity type, any entity regarding which the interaction server system 110 stores data may be a recognized entity. Each entity is provided with a unique identifier, as well as an entity type identifier (not shown).

The entity graph 810 stores information regarding relationships and associations between entities. Such relationships may be social, professional (e.g., work at a common corporation or organization), interest-based, or activity-based, merely for example. Certain relationships between entities may be unidirectional, such as a subscription by an individual user to digital content of a commercial or publishing user (e.g., a newspaper or other digital media outlet, or a brand). Other relationships may be bidirectional, such as a “friend” relationship between individual users of the interaction system 100.

Certain permissions and relationships may be attached to each relationship, and also to each direction of a relationship. For example, a bidirectional relationship (e.g., a friend relationship between individual users) may include authorization for the publication of digital content items between the individual users, but may impose certain restrictions or filters on the publication of such digital content items (e.g., based on content characteristics, location data or time of day data). Similarly, a subscription relationship between an individual user and a commercial user may impose different degrees of restrictions on the publication of digital content from the commercial user to the individual user, and may significantly restrict or block the publication of digital content from the individual user to the commercial user. A particular user, as an example of an entity, may record certain restrictions (e.g., by way of privacy settings) in a record for that entity within the entity table 808. Such privacy settings may be applied to all types of relationships within the context of the interaction system 100, or may selectively be applied to certain types of relationships.

The profile data 802 stores multiple types of profile data about a particular entity. The profile data 802 may be selectively used and presented to other users of the interaction system 100 based on privacy settings specified by a particular entity. Where the entity is an individual, the profile data 802 includes, for example, a user name, telephone number, address, settings (e.g., notification and privacy settings), as well as a user-selected avatar representation (or collection of such avatar representations). A particular user may then selectively include one or more of these avatar representations within the content of messages communicated via the interaction system 100, and on map interfaces displayed by interaction clients 104 to other users. The collection of avatar representations may include “status avatars,” which present a graphical representation of a status or activity that the user may select to communicate at a particular time.

Where the entity is a group, the profile data 802 for the group may similarly include one or more avatar representations associated with the group, in addition to the group name, members, and various settings (e.g., notifications) for the relevant group.

The database 804 also stores augmentation data, such as overlays or filters, in an augmentation table 812. The augmentation data is associated with and applied to videos (for which data is stored in a video table 814) and images (for which data is stored in an image table 816).

Filters, in some examples, are overlays that are displayed as overlaid on an image or video during presentation to a recipient user. Filters may be of various types, including user-selected filters from a set of filters presented to a sending user by the interaction client 104 when the sending user is composing a message. Other types of filters include geolocation filters (also known as geo-filters), which may be presented to a sending user based on geographic location. For example, geolocation filters specific to a neighborhood or special location may be presented within a user interface by the interaction client 104, based on geolocation information determined by a Global Positioning System (GPS) unit of the user system 102.

Another type of filter is a data filter, which may be selectively presented to a sending user by the interaction client 104 based on other inputs or information gathered by the user system 102 during the message creation process. Examples of data filters include current temperature at a specific location, a current speed at which a sending user is traveling, battery life for a user system 102, or the current time.

Other augmentation data that may be stored within the image table 816 includes augmented reality content items (e.g., corresponding to applying “lenses” or augmented reality experiences). An augmented reality content item may be a real-time special effect and sound that may be added to an image or a video.

A collections table 818 stores data regarding collections of messages and associated image, video, or audio data, which are compiled into a collection (e.g., a story or a gallery). The creation of a particular collection may be initiated by a particular user (e.g., each user for which a record is maintained in the entity table 808). A user may create a “personal story” in the form of a collection of content that has been created and sent/broadcast by that user. To this end, the user interface of the interaction client 104 may include an icon that is user-selectable to enable a sending user to add specific content to his or her personal story.

A collection may also constitute a “live story,” which is a collection of content from multiple users that is created manually, automatically, or using a combination of manual and automatic techniques. For example, a “live story” may constitute a curated stream of user-submitted content from various locations and events. Users whose client devices have location services enabled and are at a common location event at a particular time may, for example, be presented with an option, via a user interface of the interaction client 104, to contribute content to a particular live story. The live story may be identified to the user by the interaction client 104, based on his or her location. The end result is a “live story” told from a community perspective.

A further type of content collection is known as a “location story,” which enables a user whose user system 102 is located within a specific geographic location (e.g., on a college or university campus) to contribute to a particular collection. In some examples, a contribution to a location story may employ a second degree of authentication to verify that the end-user belongs to a specific organization or other entity (e.g., is a student on the university campus).

As mentioned above, the video table 814 stores video data that, in some examples, is associated with messages for which records are maintained within the message table 806. Similarly, the image table 816 stores image data associated with messages for which message data is stored in the entity table 808. The entity table 808 may associate various augmentations from the augmentation table 812 with various images and videos stored in the image table 816 and the video table 814.

### Data Communications Architecture

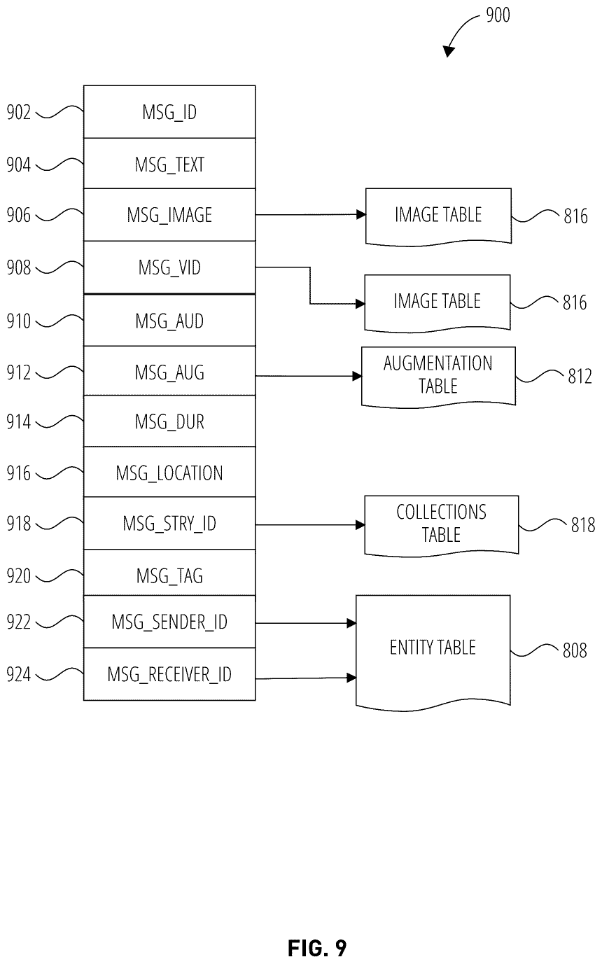

FIG. 9 is a schematic diagram illustrating a structure of a message 900, according to some examples, generated by an interaction client 104 for communication to a further interaction client 104 via the interaction servers 124. The content of a particular message 900 is used to populate the message table 806 stored within the database 804, accessible by the interaction servers 124. Similarly, the content of a message 900 is stored in memory as “in-transit” or “in-flight” data of the user system 102 or the interaction servers 124. A message 900 is shown to include the following example components:
Message identifier 902: a unique identifier that identifies the message 900.
Message text payload 904: text, to be generated by a user via a user interface of the user system 102, and that is included in the message 900.
Message image payload 906: image data, captured by a camera component of a user system 102 or retrieved from a memory component of a user system 102, and that is included in the message 900. Image data for a sent or received message 900 may be stored in the image table 816.
Message video payload 908: video data, captured by a camera component or retrieved from a memory component of the user system 102, and that is included in the message 900. Video data for a sent or received message 900 may be stored in the image table 816.
Message audio payload 910: audio data, captured by a microphone or retrieved from a memory component of the user system 102, and that is included in the message 900.
Message augmentation data 912: augmentation data (e.g., filters, stickers, or other annotations or enhancements) that represents augmentations to be applied to message image payload 906, message video payload 908, or message audio payload 910 of the message 900. Augmentation data for a sent or received message 900 may be stored in the augmentation table 812.
Message duration parameter 914: parameter value indicating, in seconds, the amount of time for which content of the message (e.g., the message image payload 906, message video payload 908, message audio payload 910) is to be presented or made accessible to a user via the interaction client 104.
Message geolocation parameter 916: geolocation data (e.g., latitudinal and longitudinal coordinates) associated with the content payload of the message. Multiple message geolocation parameter 916 values may be included in the payload, each of these parameter values being associated with respect to content items included in the content (e.g., a specific image within the message image payload 906, or a specific video in the message video payload 908).
Message story identifier 918: identifier values identifying one or more content collections (e.g., “stories” identified in the collections table 818) with which a particular content item in the message image payload 906 of the message 900 is associated. For example, multiple images within the message image payload 906 may each be associated with multiple content collections using identifier values.
Message tag 920: each message 900 may be tagged with multiple tags, each of which is indicative of the subject matter of content included in the message payload. For example, where a particular image included in the message image payload 906 depicts an animal (e.g., a lion), a tag value may be included within the message tag 920 that is indicative of the relevant animal. Tag values may be generated manually, based on user input, or may be automatically generated using, for example, image recognition.
Message sender identifier 922: an identifier (e.g., a messaging system identifier, email address, or device identifier) indicative of a user of the user system 102 on which the message 900 was generated and from which the message 900 was sent.
Message receiver identifier 924: an identifier (e.g., a messaging system identifier, email address, or device identifier) indicative of a user of the user system 102 to which the message 900 is addressed.

The contents (e.g., values) of the various components of message 900 may be pointers to locations in tables within which content data values are stored. For example, an image value in the message image payload 906 may be a pointer to (or address of) a location within an image table 816. Similarly, values within the message video payload 908 may point to data stored within an image table 816, values stored within the message augmentation data 912 may point to data stored in an augmentation table 812, values stored within the message story identifier 918 may point to data stored in a collections table 818, and values stored within the message sender identifier 922 and the message receiver identifier 924 may point to user records stored within an entity table 808.

### Machine Architecture

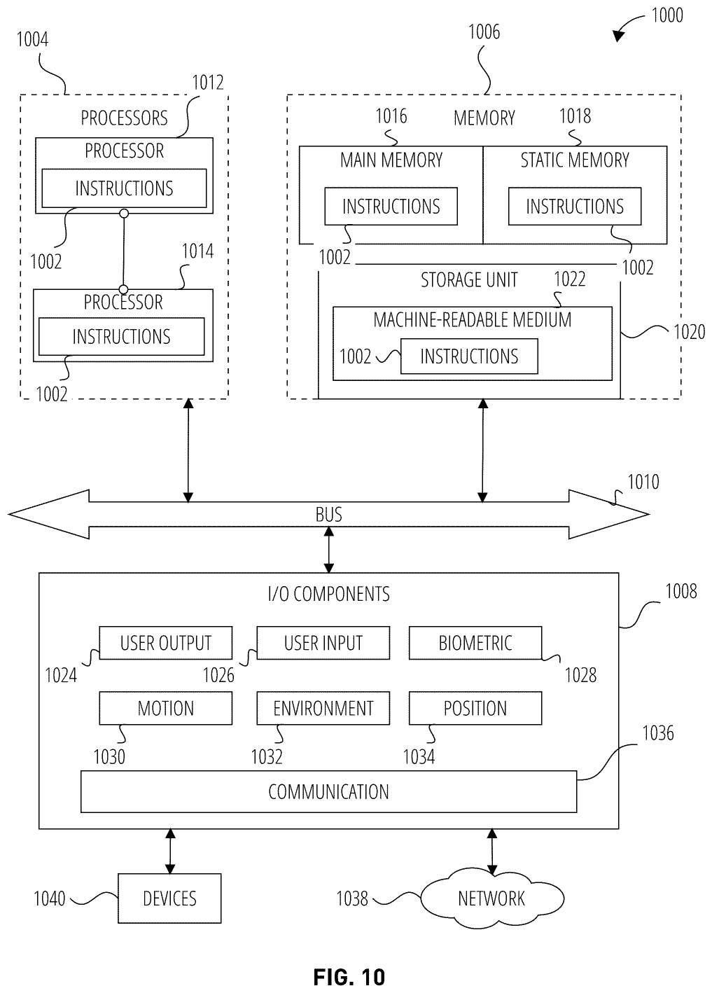

FIG. 10 is a diagrammatic representation of the machine 1000 within which instructions 1002 (e.g., software, a program, an application, an applet, an app, or other executable code) for causing the machine 1000 to perform any one or more of the methodologies discussed herein may be executed. For example, the instructions 1002 may cause the machine 1000 to execute any one or more of the methods described herein. The instructions 1002 transform the general, non-programmed machine 1000 into a particular machine 1000 programmed to carry out the described and illustrated functions in the manner described. The machine 1000 may operate as a standalone device or may be coupled (e.g., networked) to other machines. In a networked deployment, the machine 1000 may operate in the capacity of a server machine or a client machine in a server-client network environment, or as a peer machine in a peer-to-peer (or distributed) network environment. The machine 1000 may comprise, but not be limited to, a server computer, a client computer, a personal computer (PC), a tablet computer, a laptop computer, a netbook, a set-top box (STB), a personal digital assistant (PDA), an entertainment media system, a cellular telephone, a smartphone, a mobile device, a wearable device (e.g., a smartwatch), a smart home device (e.g., a smart appliance), other smart devices, a web appliance, a network router, a network switch, a network bridge, or any machine capable of executing the instructions 1002, sequentially or otherwise, that specify actions to be taken by the machine 1000. Further, while a single machine 1000 is illustrated, the term “machine” shall also be taken to include a collection of machines that individually or jointly execute the instructions 1002 to perform any one or more of the methodologies discussed herein. The machine 1000, for example, may comprise the user system 102 or any one of multiple server devices forming part of the interaction server system 110. In some examples, the machine 1000 may also comprise both client and server systems, with certain operations of a particular method or algorithm being performed on the server-side and with certain operations of the particular method or algorithm being performed on the client-side.

The machine 1000 may include processors 1004, memory 1006, and input/output I/O components 1008, which may be configured to communicate with each other via a bus 1010. In an example, the processors 1004 (e.g., a Central Processing Unit (CPU), a Reduced Instruction Set Computing (RISC) Processor, a Complex Instruction Set Computing (CISC) Processor, a Graphics Processing Unit (GPU), a Digital Signal Processor (DSP), an Application Specific Integrated Circuit (ASIC), a Radio-Frequency Integrated Circuit (RFIC), another processor, or any suitable combination thereof) may include, for example, a processor 1012 and a processor 1014 that execute the instructions 1002. The term “processor” is intended to include multi-core processors that may comprise two or more independent processors (sometimes referred to as “cores”) that may execute instructions contemporaneously. Although FIG. 10 shows multiple processors 1004, the machine 1000 may include a single processor with a single-core, a single processor with multiple cores (e.g., a multi-core processor), multiple processors with a single core, multiple processors with multiples cores, or any combination thereof.

The memory 1006 includes a main memory 1016, a static memory 1018, and a storage unit 1020, both accessible to the processors 1004 via the bus 1010. The main memory 1006, the static memory 1018, and storage unit 1020 store the instructions 1002 embodying any one or more of the methodologies or functions described herein. The instructions 1002 may also reside, completely or partially, within the main memory 1016, within the static memory 1018, within machine-readable medium 1022 within the storage unit 1020, within at least one of the processors 1004 (e.g., within the processor's cache memory), or any suitable combination thereof, during execution thereof by the machine 1000.

The I/O components 1008 may include a wide variety of components to receive input, provide output, produce output, transmit information, exchange information, capture measurements, and so on. The specific I/O components 1008 that are included in a particular machine will depend on the type of machine. For example, portable machines such as mobile phones may include a touch input device or other such input mechanisms, while a headless server machine will likely not include such a touch input device. It will be appreciated that the I/O components 1008 may include many other components that are not shown in FIG. 10. In various examples, the I/O components 1008 may include user output components 1024 and user input components 1026. The user output components 1024 may include visual components (e.g., a display such as a plasma display panel (PDP), a light-emitting diode (LED) display, a liquid crystal display (LCD), a projector, or a cathode ray tube (CRT)), acoustic components (e.g., speakers), haptic components (e.g., a vibratory motor, resistance mechanisms), other signal generators, and so forth. The user input components 1026 may include alphanumeric input components (e.g., a keyboard, a touch screen configured to receive alphanumeric input, a photo-optical keyboard, or other alphanumeric input components), point-based input components (e.g., a mouse, a touchpad, a trackball, a joystick, a motion sensor, or another pointing instrument), tactile input components (e.g., a physical button, a touch screen that provides location and force of touches or touch gestures, or other tactile input components), audio input components (e.g., a microphone), and the like.

In further examples, the I/O components 1008 may include biometric components 1028, motion components 1030, environmental components 1032, or position components 1034, among a wide array of other components. For example, the biometric components 1028 include components to detect expressions (e.g., hand expressions, facial expressions, vocal expressions, body gestures, or eye-tracking), measure biosignals (e.g., blood pressure, heart rate, body temperature, perspiration, or brain waves), identify a person (e.g., voice identification, retinal identification, facial identification, fingerprint identification, or electroencephalogram-based identification), and the like. The biometric components may include a brain-machine interface (BMI) system that allows communication between the brain and an external device or machine. This may be achieved by recording brain activity data, translating this data into a format that can be understood by a computer, and then using the resulting signals to control the device or machine.

Example types of BMI technologies, including:
Electroencephalography (EEG) based BMIs, which record electrical activity in the brain using electrodes placed on the scalp.
Invasive BMIs, which used electrodes that are surgically implanted into the brain.
Optogenetics BMIs, which use light to control the activity of specific nerve cells in the brain.

Any biometric data collected by the biometric components is captured and stored only with user approval and deleted on user request. Further, such biometric data may be used for very limited purposes, such as identification verification. To ensure limited and authorized use of biometric information and other personally identifiable information (PII), access to this data is restricted to authorized personnel only, if at all. Any use of biometric data may strictly be limited to identification verification purposes, and the data is not shared or sold to any third party without the explicit consent of the user. In addition, appropriate technical and organizational measures are implemented to ensure the security and confidentiality of this sensitive information.

The motion components 1030 include acceleration sensor components (e.g., accelerometer), gravitation sensor components, rotation sensor components (e.g., gyroscope).

The environmental components 1032 include, for example, one or more cameras, temperature sensor components (e.g., one or more thermometers that detect ambient temperature), humidity sensor components, pressure sensor components (e.g., barometer), acoustic sensor components (e.g., one or more microphones that detect background noise), proximity sensor components (e.g., infrared sensors that detect nearby objects), gas sensors (e.g., gas detection sensors to detection concentrations of hazardous gases for safety or to measure pollutants in the atmosphere), or other components that may provide indications, measurements, or signals corresponding to a surrounding physical environment.

With respect to cameras, the user system 102 may have a camera system comprising, for example, front cameras on a front surface of the user system 102 and rear cameras on a rear surface of the user system 102. The front cameras may, for example, be used to capture still images and video of a user of the user system 102 (e.g., “selfies”), which may then be augmented with augmentation data (e.g., filters) described above. The rear cameras may, for example, be used to capture still images and videos in a more traditional camera mode, with these images similarly being augmented with augmentation data. In addition to front and rear cameras, the user system 102 may also include a 360° camera for capturing 360° photographs and videos.

Further, the camera system of the user system 102 may include dual rear cameras (e.g., a primary camera as well as a depth-sensing camera), or even triple, quad or penta rear camera configurations on the front and rear sides of the user system 102. These multiple cameras systems may include a wide camera, an ultra-wide camera, a telephoto camera, a macro camera, and a depth sensor, for example.

The position components 1034 include location sensor components (e.g., a GPS receiver component), altitude sensor components (e.g., altimeters or barometers that detect air pressure from which altitude may be derived), orientation sensor components (e.g., magnetometers), and the like.

Communication may be implemented using a wide variety of technologies. The I/O components 1008 further include communication components 1036 operable to couple the machine 1000 to a network 1038 or devices 1040 via respective coupling or connections. For example, the communication components 1036 may include a network interface component or another suitable device to interface with the network 1038. In further examples, the communication components 1036 may include wired communication components, wireless communication components, cellular communication components, Near Field Communication (NFC) components, Bluetooth® components (e.g., Bluetooth® Low Energy), Wi-Fi® components, and other communication components to provide communication via other modalities. The devices 1040 may be another machine or any of a wide variety of peripheral devices (e.g., a peripheral device coupled via a USB).

Moreover, the communication components 1036 may detect identifiers or include components operable to detect identifiers. For example, the communication components 1036 may include Radio Frequency Identification (RFID) tag reader components, NFC smart tag detection components, optical reader components (e.g., an optical sensor to detect one-dimensional bar codes such as Universal Product Code (UPC) bar code, multi-dimensional bar codes such as Quick Response (QR) code, Aztec code, Data Matrix, Dataglyph™, MaxiCode, PDF417, Ultra Code, UCC RSS-2D bar code, and other optical codes), or acoustic detection components (e.g., microphones to identify tagged audio signals). In addition, a variety of information may be derived via the communication components 1036, such as location via Internet Protocol (IP) geolocation, location via Wi-Fi® signal triangulation, location via detecting an NFC beacon signal that may indicate a particular location, and so forth.

The various memories (e.g., main memory 1016, static memory 1018, and memory of the processors 1004) and storage unit 1020 may store one or more sets of instructions and data structures (e.g., software) embodying or used by any one or more of the methodologies or functions described herein. These instructions (e.g., the instructions 1002), when executed by processors 1004, cause various operations to implement the disclosed examples.

The instructions 1002 may be transmitted or received over the network 1038, using a transmission medium, via a network interface device (e.g., a network interface component included in the communication components 1036) and using any one of several well-known transfer protocols (e.g., hypertext transfer protocol (HTTP)). Similarly, the instructions 1002 may be transmitted or received using a transmission medium via a coupling (e.g., a peer-to-peer coupling) to the devices 1040.

### Software Architecture

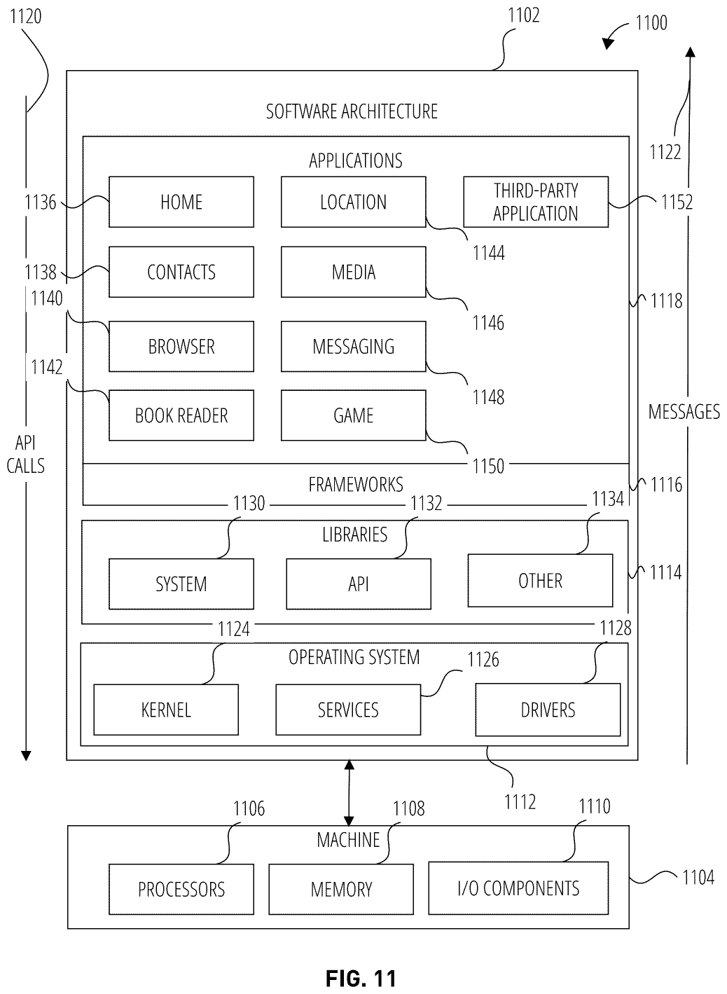

FIG. 11 is a block diagram 1100 illustrating a software architecture 1102, which can be installed on any one or more of the devices described herein. The software architecture 1102 is supported by hardware such as a machine 1104 that includes processors 1106, memory 1108, and I/O components 1110. In this example, the software architecture 1102 can be conceptualized as a stack of layers, where each layer provides a particular functionality. The software architecture 1102 includes layers such as an operating system 1112, libraries 1114, frameworks 1116, and applications 1118. Operationally, the applications 1118 invoke API calls 1120 through the software stack and receive messages 1122 in response to the API calls 1120.

The operating system 1112 manages hardware resources and provides common services. The operating system 1112 includes, for example, a kernel 1124, services 1126, and drivers 1128. The kernel 1124 acts as an abstraction layer between the hardware and the other software layers. For example, the kernel 1124 provides memory management, processor management (e.g., scheduling), component management, networking, and security settings, among other functionalities. The services 1126 can provide other common services for the other software layers. The drivers 1128 are responsible for controlling or interfacing with the underlying hardware. For instance, the drivers 1128 can include display drivers, camera drivers, BLUETOOTH® or BLUETOOTH® Low Energy drivers, flash memory drivers, serial communication drivers (e.g., USB drivers), WI-FI® drivers, audio drivers, power management drivers, and so forth.

The libraries 1114 provide a common low-level infrastructure used by the applications 1118. The libraries 1114 can include system libraries 1130 (e.g., C standard library) that provide functions such as memory allocation functions, string manipulation functions, mathematic functions, and the like. In addition, the libraries 1114 can include API libraries 1132 such as media libraries (e.g., libraries to support presentation and manipulation of various media formats such as Moving Picture Experts Group-4 (MPEG4), Advanced Video Coding (H.264 or AVC), Moving Picture Experts Group Layer-3 (MP3), Advanced Audio Coding (AAC), Adaptive Multi-Rate (AMR) audio codec, Joint Photographic Experts Group (JPEG or JPG), or Portable Network Graphics (PNG)), graphics libraries (e.g., an OpenGL framework used to render in two dimensions (2D) and three dimensions (3D) in a graphic content on a display), database libraries (e.g., SQLite to provide various relational database functions), web libraries (e.g., WebKit to provide web browsing functionality), and the like. The libraries 1114 can also include a wide variety of other libraries 1134 to provide many other APIs to the applications 1118.

The frameworks 1116 provide a common high-level infrastructure that is used by the applications 1118. For example, the frameworks 1116 provide various graphical user interface (GUI) functions, high-level resource management, and high-level location services. The frameworks 1116 can provide a broad spectrum of other APIs that can be used by the applications 1118, some of which may be specific to a particular operating system or platform.

In an example, the applications 1118 may include a home application 1136, a contacts application 1138, a browser application 1140, a book reader application 1142, a location application 1144, a media application 1146, a messaging application 1148, a game application 1150, and a broad assortment of other applications such as a third-party application 1152. The applications 1118 are programs that execute functions defined in the programs. Various programming languages can be employed to create one or more of the applications 1118, structured in a variety of manners, such as object-oriented programming languages (e.g., Objective-C, Java, or C++) or procedural programming languages (e.g., C or assembly language). In a specific example, the third-party application 1152 (e.g., an application developed using the ANDROID™ or IOS™ software development kit (SDK) by an entity other than the vendor of the particular platform) may be mobile software running on a mobile operating system such as IOS™, ANDROID™, WINDOWS® Phone, or another mobile operating system. In this example, the third-party application 1152 can invoke the API calls 1120 provided by the operating system 1112 to facilitate functionalities described herein.

### Examples

Example 1 is a system comprising: at least one processor; at least one memory component storing instructions that, when executed by the at least one processor, cause the at least one processor to perform operations comprising: receiving, at a computing device, a user query; determining a use case associated with the user query, the use case being one of at least a generic use case or a specific use case; upon determining that the use case associated with the user query is the specific use case: retrieving context information relevant to the specific use case; generating a request for a response to the user query, the request comprising a prompt and a context, the prompt comprising the user query, the context comprising a subset of the context information relevant to the specific use case; transmitting the generated request to a first machine learning (ML) agent; retrieving, from the first ML agent, the response to the user query; storing the response to the user query at the computing device; and presenting the response to the user via a user interface (UI) of the computing device.

In Example 2, the subject matter of Example 1 includes, wherein determining the use case associated with the user query further comprises: generating a classification request associated with the user query, the classification request comprising a classification prompt comprising descriptions of at least the generic use case and the specific use case; transmitting the classification request to a second ML agent; and retrieving, from the second ML agent, the use case associated with the user query.

In Example 3, the subject matter of Examples 1-2 includes, wherein retrieving context information relevant to the specific use case further comprises: computing a query embedding associated with the user query; extracting a set of keywords from the user query; retrieving, based on the query embedding or the set of keywords, a set of documents relevant to the specific use case for the user query.

In Example 4, the subject matter of Example 3 includes, wherein the context comprising a subset of the context information is determined based on selecting one or more documents from the retrieved set of documents relevant to the specific use case.

In Example 5, the subject matter of Examples 3-4 includes, wherein retrieving the set of documents relevant to the specific use case further comprises: accessing stored documents, each stored document associated with a stored document embedding; computing relevance scores, each relevance score based on computing a relevance measure based on the query embedding and a stored document embedding associated with one of the stored documents; ranking the relevance scores; determining a set of highest ranked relevance scores, a size of the set corresponding to a pre-determined threshold; retrieving the stored documents associated with the relevance scores in the determined set of highest ranked relevance scores.

In Example 6, the subject matter of Example 5 includes, wherein the relevance measure is a cosine similarity between the query embedding and the stored document embedding.

In Example 7, the subject matter of Examples 1-6 includes, generating an additional prompt based on the prompt and a prompt modification; generating an additional request for an additional response to the user query, the additional request comprising the additional prompt and the context; transmitting the generated request to the first ML agent; retrieving, from the first ML agent, the additional response to the user query; and storing the additional response to the user query at the computing device.

In Example 8, the subject matter of Example 7 includes, retrieving a ground truth value associated with the user query and an evaluation metric; accessing the response and the additional response; computing a first evaluation score associated with the prompt based on one or more of the user query, the ground truth value, and the response; computing a second evaluation score associated with the additional prompt based on one or more the user query, the ground truth value, and the additional response; selecting an evaluation score of the first evaluation score and the second evaluation score based on a predetermined criterion; and storing, at the computing device, the selected evaluation score and the associated one of the prompt or additional prompt.

In Example 9, the subject matter of Examples 7-8 includes, accessing the response and the additional response; presenting, via a first visual element of a second UI, the user query and the response; presenting, via second visual element of the second UI, the user query and the additional response; selecting, based on receiving user input, one of the response or the additional response; and storing the prompt or the additional prompt respectively associated with the selected one of the response or the additional response.

In Example 10, the subject matter of Example 9 includes, storing the prompt modification applied to the prompt to generate the additional prompt.

Example 11 is at least one non-transitory machine-readable medium (e.g., computer-readable medium) including instructions that, when executed by processing circuitry, cause the processing circuitry to perform operations to implement any of Examples 1-10.

Example 12 is an apparatus comprising means to implement any of Examples 1-10.

Example 13 is a method to implement any of Examples 1-10.

### Glossary

“Carrier signal” refers, for example, to any intangible medium that is capable of storing, encoding, or carrying instructions for execution by the machine and includes digital or analog communications signals or other intangible media to facilitate communication of such instructions. Instructions may be transmitted or received over a network using a transmission medium via a network interface device.

“Client device” refers, for example, to any machine that interfaces to a communications network to obtain resources from one or more server systems or other client devices. A client device may be, but is not limited to, a mobile phone, desktop computer, laptop, portable digital assistants (PDAs), smartphones, tablets, ultrabooks, netbooks, laptops, multi-processor systems, microprocessor-based or programmable consumer electronics, game consoles, set-top boxes, or any other communication device that a user may use to access a network.

“Communication network” refers, for example, to one or more portions of a network that may be an ad hoc network, an intranet, an extranet, a virtual private network (VPN), a local area network (LAN), a wireless LAN (WLAN), a wide area network (WAN), a wireless WAN (WWAN), a metropolitan area network (MAN), the Internet, a portion of the Internet, a portion of the Public Switched Telephone Network (PSTN), a plain old telephone service (POTS) network, a cellular telephone network, a wireless network, a Wi-Fi® network, another type of network, or a combination of two or more such networks. For example, a network or a portion of a network may include a wireless or cellular network, and the coupling may be a Code Division Multiple Access (CDMA) connection, a Global System for Mobile communications (GSM) connection, or other types of cellular or wireless coupling. In this example, the coupling may implement any of a variety of types of data transfer technology, such as Single Carrier Radio Transmission Technology (1×RTT), Evolution-Data Optimized (EVDO) technology, General Packet Radio Service (GPRS) technology, Enhanced Data rates for GSM Evolution (EDGE) technology, third Generation Partnership Project (3GPP) including 3G, fourth-generation wireless (4G) networks, Universal Mobile Telecommunications System (UMTS), High Speed Packet Access (HSPA), Worldwide Interoperability for Microwave Access (WiMAX), Long Term Evolution (LTE) standard, others defined by various standard-setting organizations, other long-range protocols, or other data transfer technology.

“Component” refers, for example, to a device, physical entity, or logic having boundaries defined by function or subroutine calls, branch points, APIs, or other technologies that provide for the partitioning or modularization of particular processing or control functions. Components may be combined via their interfaces with other components to carry out a machine process. A component may be a packaged functional hardware unit designed for use with other components and a part of a program that usually performs a particular function of related functions. Components may constitute either software components (e.g., code embodied on a machine-readable medium) or hardware components. A “hardware component” is a tangible unit capable of performing certain operations and may be configured or arranged in a certain physical manner. In various examples, one or more computer systems (e.g., a standalone computer system, a client computer system, or a server computer system) or one or more hardware components of a computer system (e.g., a processor or a group of processors) may be configured by software (e.g., an application or application portion) as a hardware component that operates to perform certain operations as described herein. A hardware component may also be implemented mechanically, electronically, or any suitable combination thereof. For example, a hardware component may include dedicated circuitry or logic that is permanently configured to perform certain operations. A hardware component may be a special-purpose processor, such as a field-programmable gate array (FPGA) or an application-specific integrated circuit (ASIC). A hardware component may also include programmable logic or circuitry that is temporarily configured by software to perform certain operations. For example, a hardware component may include software executed by a general-purpose processor or other programmable processors. Once configured by such software, hardware components become specific machines (or specific components of a machine) uniquely tailored to perform the configured functions and are no longer general-purpose processors. It will be appreciated that the decision to implement a hardware component mechanically, in dedicated and permanently configured circuitry, or in temporarily configured circuitry (e.g., configured by software), may be driven by cost and time considerations. Accordingly, the phrase “hardware component” (or “hardware-implemented component”) should be understood to encompass a tangible entity, be that an entity that is physically constructed, permanently configured (e.g., hardwired), or temporarily configured (e.g., programmed) to operate in a certain manner or to perform certain operations described herein. Considering examples in which hardware components are temporarily configured (e.g., programmed), each of the hardware components need not be configured or instantiated at any one instance in time. For example, where a hardware component comprises a general-purpose processor configured by software to become a special-purpose processor, the general-purpose processor may be configured as respectively different special-purpose processors (e.g., comprising different hardware components) at different times. Software accordingly configures a particular processor or processors, for example, to constitute a particular hardware component at one instance of time and to constitute a different hardware component at a different instance of time. Hardware components can provide information to, and receive information from, other hardware components. Accordingly, the described hardware components may be regarded as being communicatively coupled. Where multiple hardware components exist contemporaneously, communications may be achieved through signal transmission (e.g., over appropriate circuits and buses) between or among two or more of the hardware components. In examples in which multiple hardware components are configured or instantiated at different times, communications between such hardware components may be achieved, for example, through the storage and retrieval of information in memory structures to which the multiple hardware components have access. For example, one hardware component may perform an operation and store the output of that operation in a memory device to which it is communicatively coupled. A further hardware component may then, at a later time, access the memory device to retrieve and process the stored output. Hardware components may also initiate communications with input or output devices, and can operate on a resource (e.g., a collection of information). The various operations of example methods described herein may be performed, at least partially, by one or more processors that are temporarily configured (e.g., by software) or permanently configured to perform the relevant operations. Whether temporarily or permanently configured, such processors may constitute processor-implemented components that operate to perform one or more operations or functions described herein. As used herein, “processor-implemented component” refers to a hardware component implemented using one or more processors. Similarly, the methods described herein may be at least partially processor-implemented, with a particular processor or processors being an example of hardware. For example, at least some of the operations of a method may be performed by one or more processors or processor-implemented components. Moreover, the one or more processors may also operate to support performance of the relevant operations in a “cloud computing” environment or as a “software as a service” (SaaS). For example, at least some of the operations may be performed by a group of computers (as examples of machines including processors), with these operations being accessible via a network (e.g., the Internet) and via one or more appropriate interfaces (e.g., an API). The performance of certain of the operations may be distributed among the processors, not only residing within a single machine, but deployed across a number of machines. In some examples, the processors or processor-implemented components may be located in a single geographic location (e.g., within a home environment, an office environment, or a server farm). In other examples, the processors or processor-implemented components may be distributed across a number of geographic locations.

“Computer-readable storage medium” refers, for example, to both machine-storage media and transmission media. Thus, the terms include both storage devices/media and carrier waves/modulated data signals. The terms “machine-readable medium,” “computer-readable medium” and “device-readable medium” mean the same thing and may be used interchangeably in this disclosure.

“Ephemeral message” refers, for example, to a message that is accessible for a time-limited duration. An ephemeral message may be a text, an image, a video and the like. The access time for the ephemeral message may be set by the message sender. Alternatively, the access time may be a default setting or a setting specified by the recipient. Regardless of the setting technique, the message is transitory.

“Machine storage medium” refers, for example, to a single or multiple storage devices and media (e.g., a centralized or distributed database, and associated caches and servers) that store executable instructions, routines and data. The term shall accordingly be taken to include, but not be limited to, solid-state memories, and optical and magnetic media, including memory internal or external to processors. Specific examples of machine-storage media, computer-storage media and device-storage media include non-volatile memory, including by way of example semiconductor memory devices, e.g., erasable programmable read-only memory (EPROM), electrically erasable programmable read-only memory (EEPROM), FPGA, and flash memory devices; magnetic disks such as internal hard disks and removable disks; magneto-optical disks; and CD-ROM and DVD-ROM disks The terms “machine-storage medium,” “device-storage medium,” “computer-storage medium” mean the same thing and may be used interchangeably in this disclosure. The terms “machine-storage media,” “computer-storage media,” and “device-storage media” specifically exclude carrier waves, modulated data signals, and other such media, at least some of which are covered under the term “signal medium.”

“Non-transitory computer-readable storage medium” refers, for example, to a tangible medium that is capable of storing, encoding, or carrying the instructions for execution by a machine.

“Signal medium” refers, for example, to any intangible medium that is capable of storing, encoding, or carrying the instructions for execution by a machine and includes digital or analog communications signals or other intangible media to facilitate communication of software or data. The term “signal medium” shall be taken to include any form of a modulated data signal, carrier wave, and so forth. The term “modulated data signal” means a signal that has one or more of its characteristics set or changed in such a matter as to encode information in the signal. The terms “transmission medium” and “signal medium” mean the same thing and may be used interchangeably in this disclosure.

“User device” refers, for example, to a device accessed, controlled or owned by a user and with which the user interacts perform an action or interaction on the user device, including an interaction with other users or computer systems.

### Notes:

Although the example routine depicts a particular sequence of operations, the sequence may be altered without departing from the scope of the present disclosure. For example, some of the operations depicted may be performed in parallel or in a different sequence that does not materially affect the function of the routine. In other examples, different components of an example device or system that implements the routine may perform functions at substantially the same time or in a specific sequence.

What is claimed is:

1. A system comprising:
at least one processor;
at least one memory component storing instructions that, when executed by the at least one processor, cause the at least one processor to perform operations comprising:
receiving, at a computing device, a user query;
determining a use case associated with the user query, the use case being one of at least a generic use case or a specific use case; and
based on determining that the use case associated with the user query is the specific use case:
retrieving context information relevant to the specific use case;
generating a request for a response to the user query, the request comprising the user query and a subset of the context information relevant to the specific use case;
transmitting the generated request to a first machine learning (ML) agent;
retrieving, from the first ML agent, the response to the user query;
storing the response to the user query at the computing device; and
presenting the response to a user via a user interface (UI) of the computing device.

2. The system of claim 1, wherein the request comprises a prompt and a context, the prompt comprising the user query, and the context comprising the subset of the context information relevant to the use case.

3. The system of claim 1, wherein determining the use case associated with the user query further comprises:
generating a classification request associated with the user query, the classification request comprising a classification prompt comprising descriptions of at least the generic use case and the specific use case;
transmitting the classification request to a second ML agent; and
retrieving, from the second ML agent, the use case associated with the user query.

4. The system of claim 1, wherein retrieving context information relevant to the specific use case further comprises:
computing a query embedding associated with the user query;
extracting a set of keywords from the user query; and
retrieving, based on the query embedding or the set of keywords, a set of documents relevant to the specific use case for the user query.

5. The system of claim 4, wherein the subset of the context information is determined based on selecting one or more documents from the set of documents relevant to the specific use case.

6. The system of claim 4, wherein retrieving the set of documents relevant to the specific use case further comprises:
accessing stored documents, each stored document associated with a stored document embedding;
computing relevance scores, each relevance score based on computing a relevance measure based on the query embedding and a stored document embedding associated with one of the stored documents;
ranking the relevance scores;
determining a set of highest ranked relevance scores, a size of the set corresponding to a pre-determined threshold; and
retrieving the stored documents associated with the relevance scores in the set of highest ranked relevance scores.

7. The system of claim 6, wherein the relevance measure is a cosine similarity between the query embedding and the stored document embedding.

8. The system of claim 2, the operations further comprising:
generating an additional prompt based on the prompt and a prompt modification;
generating an additional request for an additional response to the user query, the additional request comprising the additional prompt and the context;
transmitting the generated additional request to the first ML agent;
retrieving, from the first ML agent, the additional response to the user query; and
storing the additional response to the user query at the computing device.

9. The system of claim 8, the operations further comprising:
retrieving a ground truth value associated with the user query and an evaluation metric;
accessing the response and the additional response;
computing a first evaluation score associated with the prompt based on one or more of the user query, the ground truth value, and the response;
computing a second evaluation score associated with the additional prompt based on one or more the user query, the ground truth value, and the additional response;
selecting an evaluation score of the first evaluation score and the second evaluation score based on a predetermined criterion; and
storing, at the computing device, the selected evaluation score and an associated one of the prompt or additional prompt.

10. The system of claim 8, the operations further comprising:
accessing the response and the additional response;
presenting, via a first visual element of a second UI, the user query and the response;
presenting, via second visual element of the second UI, the user query and the additional response;
selecting, based on receiving user input, one of the response or the additional response; and
storing the prompt or the additional prompt respectively associated with the selected one of the response or the additional response.

11. The system of claim 10, the operations further comprising storing the prompt modification applied to the prompt to generate the additional prompt.

12. A method comprising:
receiving, at a computing device, a user query;
determining a use case associated with the user query, the use case being one of at least a generic use case or a specific use case;
based on determining that the use case associated with the user query is the specific use case:
retrieving context information relevant to the specific use case;
generating a request for a response to the user query, the request comprising the user query and a subset of the context information relevant to the specific use case;
transmitting the generated request to a first machine learning (ML) agent;
retrieving, from the first ML agent, the response to the user query;
storing the response to the user query at the computing device; and
presenting the response to a user via a user interface (UI) of the computing device.

13. The method of claim 12, wherein the request comprises a prompt and a context, the prompt comprising the user query, and the context comprising the subset of the context information relevant to the use case.

14. The method of claim 12, wherein determining the use case associated with the user query further comprises:
generating a classification request associated with the user query, the classification request comprising a classification prompt comprising descriptions of at least the generic use case and the specific use case;
transmitting the classification request to a second ML agent; and
retrieving, from the second ML agent, the use case associated with the user query.

15. The method of claim 12, wherein retrieving the context information relevant to the specific use case further comprises:
computing a query embedding associated with the user query;
extracting a set of keywords from the user query; and
retrieving, based on the query embedding or the set of keywords, a set of documents relevant to the specific use case for the user query.

16. The method of claim 15, wherein the subset of the context information is determined based on selecting one or more documents from the retrieved set of documents relevant to the specific use case.

17. The method of claim 15, wherein retrieving the set of documents relevant to the determined use case further comprises:
accessing stored documents, each stored document associated with a stored document embedding;
computing relevance scores, each relevance score based on computing a relevance measure based on the query embedding and a stored document embedding associated with one of the stored documents;
ranking the relevance scores;
determining a set of highest ranked relevance scores, a size of the set corresponding to a pre-determined threshold; and
retrieving documents associated with the relevance scores in the determined set of highest ranked relevance scores.

18. The method of claim 13, further comprising:
generating an additional prompt based on the prompt and a prompt modification;
generating an additional request for an additional response to the user query, the additional request comprising the additional prompt and the context;
transmitting the generated additional request to the first ML agent;
retrieving, from the first ML agent, the additional response to the user query; and
storing the additional response to the user query at the computing device.

19. The method of claim 18, further comprising:
retrieving a ground truth value associated with the user query and an evaluation metric;
accessing the response and the additional response;
computing a first evaluation score associated with the prompt based on one or more of the user query, the ground truth value, and the response;
computing a second evaluation score associated with the additional prompt based on one or more the user query, the ground truth value, and the additional response;
selecting an evaluation score of the first evaluation score and the second evaluation score based on a predetermined criterion; and
storing, at the computing device, the selected evaluation score and an associated one of the prompt or additional prompt.

20. A non-transitory computer-readable storage medium, the computer-readable storage medium including instructions that when executed by a computer, cause the computer to:
receive, at a computing device, a user query;
determine a use case associated with the user query, the use case being one of at least a generic use case or a specific use case;
based on determining that the use case associated with the user query is the specific use case:
retrieve context information relevant to the specific use case;
generate a request for a response to the user query, the request comprising the user query and a subset of the context information relevant to the specific use case;
transmit the generated request to a first machine learning (ML) agent;
retrieve, from the first ML agent, the response to the user query;
store the response to the user query at the computing device; and
present the response to a user via a user interface (UI) of the computing device.
